(19) United States
(12) Patent Application Publication
(10) Pub. No.: US 2026/0238556 A1
(43) Pub. Date: Aug. 13, 2026

(54) METHODS TO SIGNAL NETWORK-ASSOCIATED TYPES OF AVAILABLE AI/ML ASSISTANCE INFORMATION

(71) Applicant: Telefonaktiebolaget LM Ericsson (publ), Stockholm (SE)

(72) Inventors: Pablo Soldati, Solna (SE); Luca Lunardi, Genova (IT)

(21) Appl. No.: 19/155,326

(22) PCT Filed: Feb. 9, 2024
(86) PCT No.: PCT/EP2024/053345

§ 371 Date: Aug. 11, 2025

Related U.S. Application Data
(60) Provisional application No. 63/485,082, filed on Feb. 15, 2023.
(60) Provisional application No. 63/487,052, filed on Feb. 27, 2023.

(51) Int. Cl. H04L 41/16

(52) U.S. Cl. CPC H04L 41/16

(57) ABSTRACT

Systems and methods related to signaling network-associated types of available assistance information (e.g., Artificial Intelligence (AI) or Machine Learning (ML) assistance information) are disclosed. In one embodiment, a method performed by a node (e.g., a second network node or a user device) comprises receiving, from a first network node, a first message comprising information that indicates network-associated types of available AI or ML assistance information pertaining to the first network node that the first network node can provide. In this manner, obtaining assistance information that may be used for executing a certain task (e.g., inferring an AI/ML based actions/recommendation on energy saving) can be obtained in an efficient manner.

### RELATED APPLICATIONS

This application claims the benefit of provisional patent application Ser. No. 63/485,082, filed Feb. 15, 2023 and provisional patent application Ser. No. 63/487,052, filed Feb. 27, 2023, the disclosures of which are hereby incorporated herein by reference in their entireties.

### TECHNICAL FIELD

The present disclosure relates to a cellular communications system and, more specifically, systems and methods for indication of availability of network associated types of Artificial Intelligence (AI) or Machine Learning (ML) assistance information.

### BACKGROUND

The current 5th Generation (5G) Radio Access Network (RAN) (also referred to as the Next Generation RAN (NG-RAN)) architecture is depicted in FIG. 1 and described in 3rd Generation Partnership Project (3GPP) Technical Specification (TS) 38.401 v17.2.0 as follows. The NG-RAN consists of a set of gNodeBs (gNBs) connected to the 5G Core (5GC) through the Next Generation (NG) interface. As specified in 3GPP TS 38.300 v17.3.0, NG-RAN could also include a set of next generation eNodeBs (ng-eNBs), where an ng-eNB may consist of an ng-eNB-Central Unit (CU) and one or more ng-eNB-Distributed Units (DUs). An ng-eNB-CU and an ng-eNB-DU is connected via W1 interface. The general principle described here also applies to ng-eNB and W1 interface, if not explicitly specified otherwise.
An gNB can support Frequency Division Duplexing (FDD) mode, Time Division Duplexing (TDD) mode, or dual mode operation.
gNBs can be interconnected through the Xn interface.
A gNB may consist of a gNB-CU and one or more gNB-DU(s). A gNB-CU and a gNB-DU is connected via F1 interface.
One gNB-DU is connected to only one gNB-CU.
NG, Xn, and F1 are logical interfaces.

For NG-RAN, the NG and Xn-C interfaces for a gNB consisting of a gNB-CU and gNB-DUs terminate in the gNB-CU. For Evolved Universal Terrestrial Radio Access (EUTRA)-New Radio (NR) Dual Connectivity (EN-DC), the S1-U and X2-C interfaces for a gNB consisting of a gNB-CU and gNB-DUs terminate in the gNB-CU. The gNB-CU and connected gNB-DUs are only visible to other gNBs and the 5GC as a gNB. A possible deployment scenario is described in Annex A of 3GPP TS 38.401.

The node hosting user plane part of the NR Packet Data Convergence Protocol (PDCP) (e.g., gNB-CU, gNB-CU-User Plane (UP), and for EN-DC, Master eNB (MeNB) or SgNB depending on the bearer split) performs user inactivity monitoring and further informs its inactivity or (re) activation to the node having the control plane (C-plane) connection towards the core network (e.g., over E1, X2). The node hosting NR Radio Link Control (RLC) (e.g., gNB-DU) may perform user inactivity monitoring and further inform its inactivity or (re) activation to the node hosting control plane, e.g. gNB-CU or gNB-CU-Control Plane (CP).

Uplink (UL) PDCP configuration (i.e. how the User Equipment (UE) uses the UL at the assisting node) is indicated via X2-C(for EN-DC), Xn-C(for NG-RAN) and F1-C. Radio Link Outage/Resume for downlink (DL) and/or UL is indicated via X2-U (for EN-DC), Xn-U (for NG-RAN), and F1-U.

The NG-RAN is layered into a Radio Network Layer (RNL) and a Transport Network Layer (TNL).

The NG-RAN architecture, i.e. the NG-RAN logical nodes and interfaces between them, is defined as part of the RNL. For each NG-RAN interface (NG, Xn, F1) the related TNL protocol and the functionality are specified. The TNL provides services for user plane transport, signaling transport.

It needs to be mentioned that the architecture shown in FIG. 1 is what 3GPP has defined for 5G. Other standardization groups, such as the Open RAN (ORAN), have further extended the architecture above and have for example split the gNB-DU into two further nodes connected by a fronthaul interface. The lower node of the split gNB-DU would contain the PHY protocol and the radio frequency (RF) parts, the upper node of the split gNB-DU would host the RLC and Medium Access Control (MAC). In ORAN the upper node is called O-DU, while the lower node is called O-Radio Unit (RU).

At the current state-of-art, the coordination across RAN and Transport domains is typically managed in non-real-time mode (e.g., pre-planning and provisioning the Transport domain) with the alternative being to coordinate Radio and Transport domains at the Service Orchestration level. However, no products are yet available on the market.

In case of dynamic changes in the allocated RAN capacity, it should be possible to optimize the Transport capacity accordingly. Mobility Load Balancing is envisaged as one of the use cases where tighter coordination between RAN and Transport is required. It is also noted that the transport network is a contributor to the overall latency and resilience of the mobile services and this aspect is particularly important in the case of Ultra-Reliable Low-Latency Communication (URLLC) services according to 3GPP standard specification.

The 3GPP RAN3 Study Item (SI) “Study on enhancement for data collection for NR and EN-DC” studied general high-level principles, functional framework, and potential use cases for Artificial Intelligence (AI)-enabled RAN. The accomplishments of the study are documented in 3GPP Technical Report (TR) 37.817 v17.0.0. The normative work based on the conclusion of Rel-17 SI is currently undertaken in 3GPP Rel-18, and the related Work Item (WI) is described in RP-213602.

The following agreements were made at RAN3 #117bis-e:
Signaling describing the capability to support specific information predictions used for AI/Machine Learning (ML) is not pursued in this release;
Signaling describing the capability to supports specific AI/ML use cases is not pursued in this release;
AI/ML capability exchange in NG-RAN can be achieved by means of procedures for AI/ML information request, AI/ML information response and AI/ML Information Request Failure.

The 3GPP RAN1 Working Group is currently working on a SI on AI/ML for NR Air Interface. A description of the objectives of this can be found in RP-213599.

### SUMMARY

It is an object of the disclosure to provide systems and methods related to signaling network-associated types of available assistance information (e.g., Artificial Intelligence (AI) or Machine Learning (ML) assistance information). In one embodiment, a method performed by a node (e.g., a second network node or a user device) comprises receiving, from a first network node, a first message comprising information that indicates network-associated types of available AI or ML assistance that the first network node can provide. In this manner, obtaining assistance information that may be used for executing a certain task (e.g., inferring an AI/ML based actions/recommendation on energy saving) can be obtained in an efficient manner.

In one embodiment, the method further comprises performing one or more actions using the received information. In one embodiment, the one or more actions comprise sending a request to the first network node for at least one of the indicated network-associated types of available AI or ML assistance information. In another embodiment, the one or more actions comprise sending a request to the first network node for at least one of the indicated network-associated types of available AI or ML assistance information, receiving the at least one of the indicated network-associated types of available AI or ML assistance information from the first network node, and performing one or more AI or ML related operations (e.g., update or train an AI or ML model) based on the at least one of the indicated network-associated types of available AI or ML assistance information received from the first network node. In another embodiment, the one or more actions comprise sending at least some of the received information to another node (e.g., to a network node or user device).

In one embodiment, the network-associated types of available AI or ML assistance information pertain to the first network node or a third network node.

In one embodiment, the node is a second network node. In one embodiment, the method further comprises, prior to receiving the first message, sending, to the first network node, a request for the information that indicates network-associated types of available AI or ML assistance information pertaining to the first network node that the first network node can provide. In one embodiment, the method further comprises sending, to the first network node, a request for at least one of the network-associated types of AI or ML assistance information pertaining to the first network node that the first network node can provide. In one embodiment, the method further comprises receiving, from the first network node, an ACK, partial ACK, or NACK in response to the request. In one embodiment, the method further comprises receiving, from the first network node, at least some of the requested at least one of the network-associated types of AI or ML assistance information pertaining to the first network node that the first network node can provide. In another embodiment, the method further comprises receiving, from the first network node, a NACK or partial NACK in response to the request. In one embodiment, the method further comprises receiving, from the first network node, updated information that indicates network-associated types of available AI or ML assistance information pertaining to the first network node that the first network node can provide. In one embodiment, the method further comprises, prior to receiving the updated information from the first network node, sending, to the first network node, a request for (updated) information that indicates network-associated types of available AI or ML assistance information pertaining to the first network node that the first network node can provide. In another embodiment, the method further comprises sending a second message to the first network node, the second message comprising information that indicates network-associated types of available AI or ML assistance information pertaining to the second network node that the second network node can provide.

In one embodiment, the node is a user device (e.g., a UE). In one embodiment, the method further comprises sending, to the first network node, a request for at least one of the network-associated types of available AI or ML assistance information pertaining to the first network node that the first network node can provide, and receiving, from the first network node, the at least one of the network-associated types of available AI or ML assistance information pertaining to the first network node that the first network node can provide. In another embodiment, the method of further comprises, prior to receiving the first message from the first network node, sending, to the first network node, a request for the information that indicates network-associated types of available AI or ML assistance information pertaining to the first network node that the first network node can provide.

Corresponding embodiments of node are also disclosed.

Embodiments of a method performed by a first network node are also disclosed. In one embodiment, a method performed by a first network node comprises sending, to a node (e.g., a second network node or a user device), a first message comprising information that indicates network-associated types of available artificial intelligence, AI, or machine learning, ML, assistance information pertaining to the first network node that the first network node can provide. In one embodiment, the node is a second network node. In another embodiment, the node is a user device (e.g., a UE).

Corresponding embodiments of a first network node are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the Next Generation Radio Access Network (NG-RAN) architecture defined in 3rd Generation Partnership Project (3GPP) specifications;

FIG. 2 is an illustration of an example method executed by the first network node to exchange what assistance information is available at the first network related to Artificial Intelligence (AI) or Machine Learning (ML).

FIG. 3 is an illustration of an example of a method wherein a first network node transmits a FIRST MESSAGE to a second network node, where the FIRST MESSAGE indicates the network-associated types of available AI/ML assistance information at the first network node. The second network node further transmit a SECOND MESSAGE indicating the network-associated types of available AI/ML assistance information at the second node.

FIG. 4 is an illustration of an example of a method where the first network node further receives a third message comprising a request to provide AI/ML assistance information.

FIG. 5 is an illustration of an example of a method wherein the first network node, upon receiving a THIRD MESSAGE, may further transmit a FOURTH MESSAGE and FIFTH MESSAGE to the second network node. Dashed lines indicate signals that are optionally transmitted in this example.

FIG. 6 is an illustration of an example of how the first network node may autonomously indicate an updated network-associated types of available AI/ML assistance information during a report procedure for AI/ML assistance information.

FIG. 7 is an illustration of example of how the first network node may indicate an updated network-associated types of available AI/ML assistance information during a report procedure for AI/ML assistance information. In this case, the transmission of a new FIRST MESSAGE is conditioned to receiving a SECOND MESSAGE from the second network node.

FIG. 8 illustrates an example embodiment of another variant of the present disclosure.

FIG. 9 illustrates an example embodiment of another variant of the present disclosure.

FIG. 10 illustrates an example embodiment of another variant of the present disclosure.

FIG. 11 illustrates one example of a cellular communications system according to some embodiments of the present disclosure.

FIG. 12 is a schematic block diagram of a radio access node according to some embodiments of the present disclosure.

FIG. 13 is a schematic block diagram that illustrates a virtualized embodiment of the radio access node of FIG. 12 according to some embodiments of the present disclosure.

FIG. 14 is a schematic block diagram of the radio access node of FIG. 12 according to some other embodiments of the present disclosure.

FIG. 15 is a schematic block diagram of a User Equipment device (UE) according to some embodiments of the present disclosure.

FIG. 16 is a schematic block diagram of the UE of FIG. 15 according to some other embodiments of the present disclosure.

FIG. 17 illustrates a telecommunication network connected via an intermediate network to a host computer in accordance with some embodiments of the present disclosure.

FIG. 18 is a generalized block diagram of a host computer communicating via a base station with a UE over a partially wireless connection in accordance with some embodiments of the present disclosure.

FIG. 19 is a flowchart illustrating a method implemented in a communication system in accordance with one embodiment of the present disclosure.

FIG. 20 is a flowchart illustrating a method implemented in a communication system in accordance with one embodiment of the present disclosure.

FIG. 21 is a flowchart illustrating a method implemented in a communication system in accordance with one embodiment of the present disclosure.

FIG. 22 is a flowchart illustrating a method implemented in a communication system in accordance with one embodiment of the present disclosure.

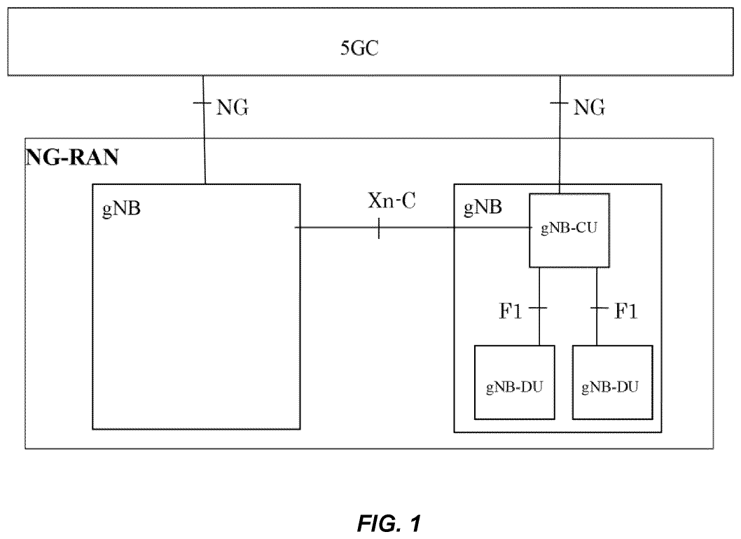

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Note the following about some terminology used in the following description:
As used herein, a network node can be a Radio Access Network (RAN) node, an Operations,

Administration, and Maintenance (OAM), a Core Network node, an Service Management and Orchestration (SMO), a Network Management System (NMS), a Non-Real Time RAN Intelligent Controller (Non-RT RIC), a Real-Time RAN Intelligent Controller (RT-RIC), a gNodeB (gNB), eNodeB (eNB), en-gNB, next generation eNB (ng-eNB), gNB-Central Unit (CU), gNB-CU-Control Plane (CP), gNB-CU-User Plane (UP), eNB-CU, eNB-CU-CP, eNB-CU-UP, Integrated Access and Backhaul (IAB)-node, IAB-donor DU, IAB-donor-CU, IAB-DU, IAB-Mobile Termination (MT), Open RAN (O)-CU, O-CU-CP, O-CU-UP, O-DU, O-Radio Unit (RU), O-eNB, a user device, an Artificial Intelligence (AI)/Machine Learning (ML) server.
The terms model training, model optimizing, model optimization, model updating are herein used interchangeably with the same meaning unless explicitly specified otherwise.
The terms model changing, modifying, or similar are herein used interchangeably with the same meaning unless explicitly specified otherwise. In particular, they refer to the fact that the type, structure, parameters, connectivity of an AI/ML model may have changed compared to a previous format/configuration of the AI/ML model.
The terms AI/ML model, AI/ML policy, AI/ML algorithm, as well as the terms, model, policy, or algorithm are herein used interchangeably with the same meaning unless explicitly specified otherwise.
References to “network nodes” herein should be understood such that a network node may be a physical node or a function or logical entity of any kind, e.g., a software entity implemented in a data center or a cloud, e.g., using one or more virtual machines, and two network nodes may well be implemented as logical software entities in the same data center or cloud.
The terms action type, action type identifier, action type ID, or types of RAN-associated action are used interchangeably with the same meaning, i.e., an indication of an action type
The terms action instance, specific action instance, action instance identifier, action instance ID, action ID are used interchangeably with the same meaning, i.e., an indication of an instance of a specific action.
The terms “AI/ML”, “AIML”, “MLAI”, “ML/AI” can be used interchangeably in the present disclosure.

Embodiments of the system and methods described herein are independent with respect to specific AI/ML model types or learning problems/setting (e.g., supervised learning, unsupervised learning, reinforcement learning, hybrid learning, centralized learning, federated learning, distributed learning, . . . )

Non-limiting examples of AI/ML algorithms may include supervised learning algorithms, deep learning algorithms, reinforcement learning types of RAN-associated algorithms (such as DQN, A2C, A3C, etc.), contextual multi-armed bandit algorithms, autoregression algorithms, etc., or combinations thereof.

Such algorithms may exploit functional approximation models, hereafter referred to as AI/ML models, such as neural networks (e.g., feedforward neural networks, deep neural networks, recurrent neural networks, convolutional neural networks, etc.).

Examples of reinforcement learning algorithms may include deep reinforcement learning (such as deep Q-network (DQN), proximal policy optimization (PPO), double Q-learning), actor-critic algorithms (such as Advantage actor-critic algorithms, e.g. A2C or A3C, actor-critic with experience replay, etc.), policy gradient algorithms, off-policy learning algorithms, etc.

Before describing embodiments of the present disclosure in detail, a discussion of a number of challenges with existing technology is beneficial. Some general agreements have been achieved on how to support AI/ML in RAN. For example, it has been agreed that AI/ML capability exchange in NG-RAN can be achieved by means of procedures for AI/ML information request, AI/ML information response, and AI/ML Information Request Failure. However, it is unclear how to make an efficient use of network related AI/ML capabilities in the RAN.

### 1 Summary of at least some Embodiments of the Present Disclosure

Systems and methods that provide a solution(s) to the above-reference and/or other challenges are disclosed herein. Embodiments of a method are provided for a first network node to indicate to a second network node the network-associated types of available AI/ML assistance information (e.g., types of RAN-associated AI/ML assistance information) pertaining the first network node that can be provided to a second network node. The first network node can then provide the assistance information itself in subsequent signaling steps, either as part of the same signaling procedure that is used to indicate the network-associated types of available AI/ML assistance information or with a separate signaling procedure.

Although the general term network-associated types of available AI/ML assistance information is used herein, it should be clear that the embodiments described herein are applicable to any types of RAN-associated available assistance information that the first network node can provide, thus not necessarily pertaining support of AI/ML operations. Example may include, for instance, assistance information associated to load optimization, assistance information associated to energy saving optimization, assistance information associated to mobility optimization, etc.

### 1.1 Method Executed by a First Network Node

Embodiments are disclosed that relate to a method executed by a first network node to exchange an indication with a second network node or user device related to network-associated types of available AI/ML assistance information, pertaining to the first network node, that the first network node can provide. In one embodiment, the method comprises the steps of:
transmitting a FIRST MESSAGE to a second network node or a user device, the FIRST MESSAGE indicating the network-associated types of available AI/ML assistance information, pertaining the first network node, that the first network node can provide or an indication that the first network node can provide AI/ML assistance information.

Variant 1: In this variant, the FIRST MESSAGE is transmitted from the first network node to a second network node.

In one variant of the method, wherein the first network node transmits the FIRST MESSAGE to a second network node, the first network node may
Optionally receive a SECOND MESSAGE from the second network node, wherein the SECOND MESSAGE may comprise one or more of:
   A request to the first network node to indicate the network-associated types of available AI/ML assistance information that the first network node can provide.
   An indication of the network-associated types of available AI/ML assistance information, pertaining the second network node, that the second node can provide.

In one embodiment, the FIRST MESSAGE and SECOND MESSAGE are the same type of RAN-associated message (e.g., they can be implemented with the same 3GPP message).

In one embodiment, the first network node may further perform one or more of the following steps:
receiving from the second network node a THIRD MESSAGE comprising a request to provide one or more of the network-associated AI/ML assistance information indicated by the first network node to the second network node by means of the FIRST MESSAGE,
transmitting a FOURTH MESSAGE comprising either a positive acknowledgment (ACK) or a negative acknowledgment (NACK) for the information requested by the second network node,
transmitting one or more FIFTH MESSAGE(s) providing network-associated AI/ML assistance information updates as requested by the second network node with the THIRD MESSAGE.

In one embodiment, any of the THIRD MESSAGE, FOURTH MESSAGE and FIFTH MESSAGE belong to the same or to a different signaling procedure used to transmit the FIRST and/or SECOND MESSAGEs. For example, in one embodiment, the SECOND MESSAGE and THIRD MESSAGE are the same type of request message belonging to the same signaling procedure.

Variant 2: The FIRST MESSAGE is transmitted from the first network node to a user device.

In one variant of the method, wherein the first network node transmits the FIRST MESSAGE to a user device, the first network node may
Optionally receive a SEVENTH MESSAGE from the user device, the SEVENTH MESSAGE comprising a request to the first network node to indicate the network-associated types of available AI/ML assistance information that the first network node can provide.

### 1.2 Method Executed by a Second Network Node (in Variant 1)

Embodiments of a method executed by a second network node are also disclosed. In one embodiment, the method comprises the steps of:
receiving a FIRST MESSAGE from a first network node, the FIRST MESSAGE indicating the network-associated types of available AI/ML assistance information, pertaining the first network node, that the first network node can provide, or an indication that the first network node can provide assistance information; and
Optionally transmitting a SECOND MESSAGE to the first network node, wherein the SECOND MESSAGE may comprise one or more of:
   a request to the first network node to indicate the network-associated types of available AI/ML assistance information that the first network node can provide; and
   an indication of the network-associated types of available AI/ML assistance information, pertaining the second network node, that the second node can provide.

Additional embodiments follow from the methods executed by the first network node.

### 1.3 Method Executed by a User Device (in Variant 2)

Embodiments of a method executed by a second network node are also disclosed. In one embodiment, the method comprises the steps of:
receiving a FIRST MESSAGE from a first network node, the FIRST MESSAGE indicating the network-associated types of available AI/ML assistance information, pertaining the first network node, that the first network node can provide, or an indication that the first network node can provide such assistance information; and
optionally transmitting a SEVENTH MESSAGE to the first network node, comprising a request to the first network node to indicate network-associated types of available AI/ML assistance information that the first network node can provide.

Additional embodiments follow from the methods executed by the first network node.

### 1.4 Advantages

Embodiments of the present disclosure may provide a number of advantages. One advantage of at least some embodiments of the proposed solution is that assistance information that may be used by a network node for executing a certain task (e.g., inferring an AI/ML based actions/recommendation on energy saving) can be obtained in an efficient manner.

Without this solution, an iterative process can be used, wherein, in a loop fashion, in a first step certain assistance information is requested and in a second step the requesting node or a user device discovers (from the response) whether such assistance information is or available or not. The loop is repeated as many network-associated types of available AI/ML assistance information as the requesting node is interested to receive.

With this solution, a node indicates to either another node or to a user device the network-associated types of available AI/ML assistance information it can offer, so that if the other node interested to receive some assistance information, it knows beforehand exactly what can be achieved and what not. This reduces the signaling overhead, reduces the time to acquire the wanted information, and makes the signaling clearer.

Furthermore, in case the network-associated types of available AI/ML assistance information changes over time, the same interested nodes can promptly realize the new situation.

### 2 Embodiments of Variant 1 (First Network Node and a Second Network Node)

According to the present disclosure, a first network node indicates, to a second network node, the network-associated types of available AI/ML assistance information pertaining the first network node that the first network node can provide.

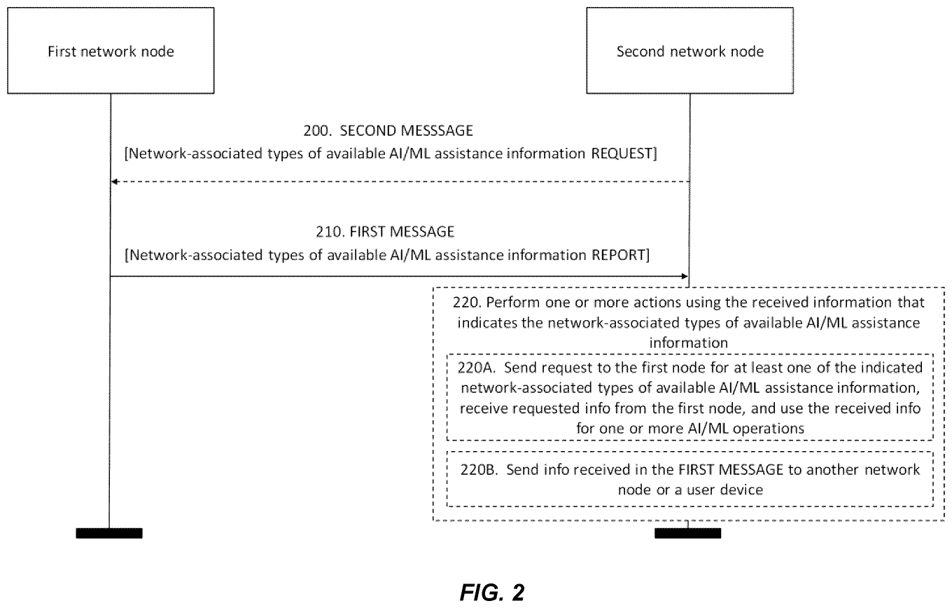

FIG. 2 illustrates one example embodiment of a procedure performed by a first network node and a second network node in accordance with Variant 1. In other words, FIG. 2 is an illustration of an example method executed by the first network node to exchange what assistance information is available at the first network related to AI/ML. Optional steps are represented by dashed lines/boxes. As illustrated, the first network node sends a FIRST MESSAGE to the second network node (step 202). The FIRST MESSAGE contains network-associated types of available AI/ML assistance information pertaining the first network node that the first network node can provide. Such available AI/ML assistance information can be used by the second network node to determine whether and how the second network node can obtain AI/ML assistance information from the first network node to support AI/ML algorithms at the second network node, such as algorithm for predictions/inferences.

In one embodiment, as illustrated in FIG. 2, the first network node, prior to sending the FIRST MESSAGE, may optionally receive from the second network node a SECOND MESSAGE (step 200). The SECOND MESSAGE comprising a request of the second network node, to receive the network-associated types of available AI/ML assistance information types pertaining the first network node that the first network node can provide. In this case, the first network node transmits the FIRST MESSAGE in response to receiving the SECOND MESSAGE.

As also illustrated in FIG. 2, in one embodiment, the second network node uses the received information that indicates the network-associated types of available AI/ML assistance information types pertaining the first network node that the first network node can provide to perform one or more actions (step 220). The one or more actions can be any desirable action(s). For example, the second network node may use this received information to request at least one of the network-associated types of available AI/ML assistance information from the first network node (step 220A). The second node may then, for example, receive the at least one of the network-associated types of available AI/ML assistance information from the first network node and use this information for one or more AI/ML operations (e.g., train or update an AI or ML model, or any action that that can use the received information) (also see step 220A). As another example, the second network node may send the information received in the FIRST MESSAGE to another network node or a user device (step 220B).

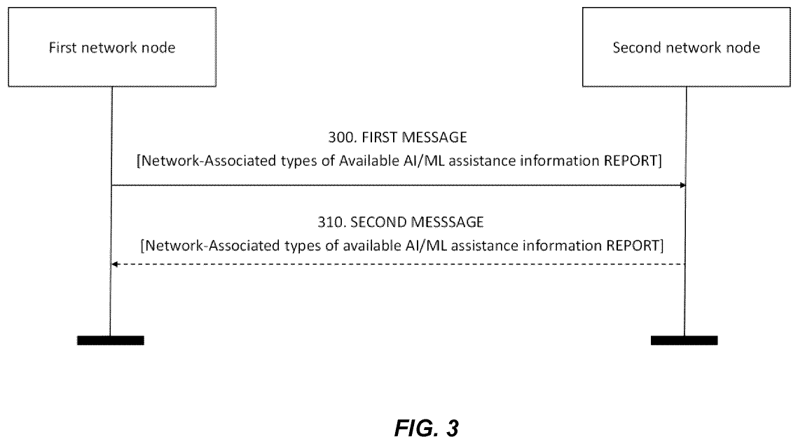

In one embodiment, the FIRST MESSAGE may optionally comprise, implicitly or explicitly, a request to obtain network-associated types of available AI/ML assistance information pertaining the second network node. In one example, illustrated in FIG. 3, the first network node sends the FIRST MESSAGE to the second network node (step 300), and the first network node receives a SECOND MESSAGE from the second network node (step 310). The SECOND MESSAGE may optionally comprise the network-associated types of available AI/ML assistance information pertaining the second network node that the second network node can provide. In this case, the SECOND MESSAGE may be used to report network-associated types of available AI/ML assistance information for the second network node (the SECOND MESSAGE traveling in the opposite direction as compared to the FIRST MESSAGE), and it may be received by the first network node in response to transmitting the FIRST MESSAGE to the second network node. In other words, the transmission of the FIRST MESSAGE implicitly triggers the second network node to transmit a SECOND MESSAGE comprising the network-associated types of available AI/ML assistance information pertaining the second network node that the second network node can provide. Again, dashed lines indicate signals that are optionally transmitted in this example.

In one embodiment, the FIRST MESSAGE and the SECOND MESSAGE are comprised in the same logical procedure for a signaling interface (e.g. in one example of realization, the FIRST MESSAGE is the response message of the Xn Setup XnAP procedure, i.e. the XN SETUP RESPONSE XnAP message, and the SECOND MESSAGE is the initiating message of the Xn Setup XnAP procedure, i.e. the XN SETUP REQUEST XnAP message; in another example of realization, the FIRST MESSAGE and the SECOND MESSAGE are comprised in one signaling procedure designed for AI/ML, such as an “AIML Information Transfer” XnAP procedure).

In another embodiment, the FIRST MESSAGE and the SECOND MESSAGE are comprised in different logical procedures for a signaling interface (e.g., the SECOND MESSAGE is the initiating message of a first class 1 procedure, such as the “AIML Information Reporting Initiation” XnAP procedure, and the FIRST MESSAGE is the initiating message of a second class 2 procedure, such as the “AIML Information Reporting” XnAP procedure). Note: a “class 1” procedure comprises an initiating message, a response message and optionally a failure message, a class 2 procedure comprises only an initiating message.

### 2.1 Additional Signaling Aspects of Variant 1

### Variant 1a 2.1.1

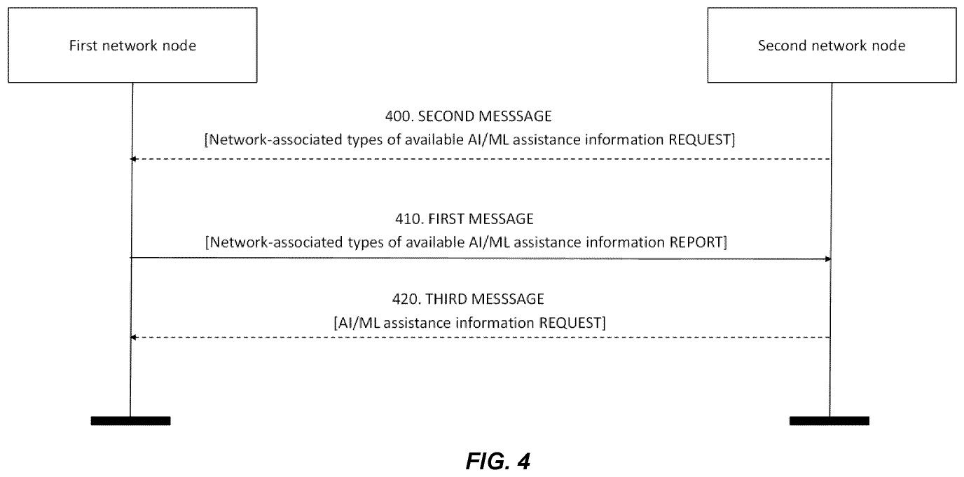

FIG. 4 illustrates one example embodiment of Variant 1a. Dashed lines indicate signals that are optionally transmitted in this example. In the embodiment illustrated in FIG. 4, the first network node optionally receives the SECOND MESSAGE from the second network node (step 400). The first network node sends the FIRST MESSAGE to the second node (step 410). The first network node may additionally receive a THIRD MESSAGE from the second network node (step 420). The THIRD MESSAGE comprises a request to provide one or more of the network-associated AI/ML assistance information indicated by the first network node to the second network node by means of the first message. Therefore, the second network node, upon receiving a FIRST MESSAGE indicating the network-associated types of available AI/ML assistance information that the first network node can provide, can efficiently request any of the AI/ML assistance information available at the first network node with the THIRD MESSAGE.

In one embodiment, the FIRST MESSAGE and/or SECOND MESSAGE and the THIRD MESSAGE are comprised in the same logical procedure for a signaling interface (e.g., the Xn Setup XnAP procedure). In one example, the SECOND MESSAGE and the THIRD MESSAGE are the same types of request message of the same logical procedure for a signaling interface, but with one or more information elements are configured with different values. For instance, the SECOND MESSAGE and the THIRD MESSAGE can be an initiating message of an AI/ML assistance information procedure, wherein
The second network node transmits the SECOND MESSAGE to request to the first network node an indication or a list of the available AI/ML assistance information that the first network node can provide.
   This request could be indicated, for instance, by a single bit of information, e.g. referred to as types of RAN associated available AI/ML assistance information) which could be set to a specific value (e.g., 1 or 0), as exemplified in Section 4.2.
   According to one embodiment, if only the Types of RAN associated Available AI/ML Assistance Information bit is set to 1, then it implies a request to receive assistance information for all available types of predictions and associated formats (e.g., the reference prediction time and/or reliability conditions).
   According to another embodiment, if the Types of RAN associated Available AI/ML Assistance Information bit is set to 1, and at least another bit associated to a specific prediction type is also set to 1 (e.g., a Second Bit associated to Predicted Energy Efficiency), then it implies a request to receive assistance information only for the indicated types of predictions.
   The first network node replies by transmitting the FIRST MESSAGE indicating the network-associated types of available AI/ML assistance information that can be provided. Such exchange of message remains valid as long as there is no change in the network-associated types of available AI/ML assistance information that the first network node can provide.
Upon receiving the FIRST MESSAGE, the second network node may trigger a procedure to obtain network-associated AI/ML assistance information from the first network node by transmitting a THIRD MESSAGE, requesting the first network node to provide one or more of the previously indicated network-associated AI/ML assistance information.
   In one embodiment, the THIRD MESSAGE could be same as the SECOND MESSAGE, and this request could be indicated, for instance, by setting one or more information bits of the THIRD MESSAGE to a specific value (e.g., 1 or 0), as exemplified in Section 4.2.

In another embodiment, the FIRST MESSAGE and/or SECOND MESSAGE and the THIRD, MESSAGE are comprised in different logical procedures for a signaling interface. For instance, the FIRST MESSAGE (and optionally the SECOND MESSAGE) is comprised in an Xn Setup XnAP procedure (for instance the FIRST MESSAGE is an XN SETUP RESPONSE message and the SECOND MESSAGE is an XN SETUP REQUEST message, while the THIRD MESSAGE is comprised in an AI/ML Information Reporting Initialization XnAP procedure (for instance the THIRD MESSAGE is an AIML INFORMATION REQUEST XnAP message).

### 2.1.2 Variant 1b

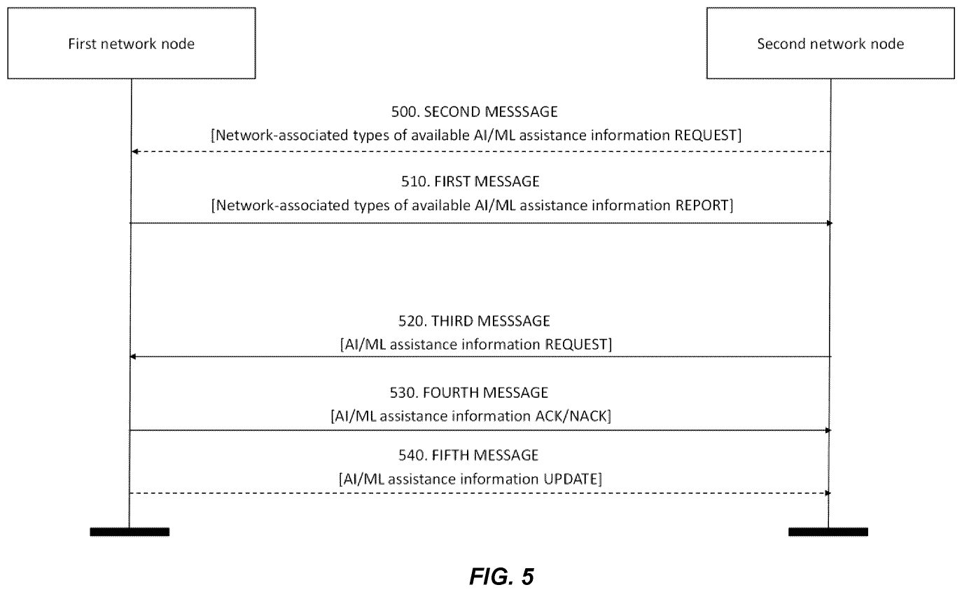

FIG. 5 is an illustration of an example of one embodiment of a method in accordance with Variant 1b. Again, dashed lines indicate signals that are optionally transmitted in this example. Steps 500, 510, and 520 are the same as steps 400, 410, and 420 of FIG. 4. In one embodiment, as illustrated in FIG. 5, the first network node may further transmit a FOURTH MESSAGE (step 530). The FOURTH MESSAGE comprises either a positive acknowledgment (ACK) or a negative acknowledgment (NACK) for the information requested by the second network node. When the FOURTH MESSAGE provides a positive acknowledgement for the assistance information requested by the second network node, the first network node may additionally transmit one or more FIFTH MESSAGEs providing AI/ML assistance information updates as requested by the second network node with the THIRD MESSAGE (step 540).
In one example of this embodiment, the FIRST MESSAGE and/or SECOND MESSAGE and the THIRD, FOURTH and FIFTH MESSAGE are comprised in the same logical procedure for a signaling interface (e.g., the Xn Setup XnAP procedure). For instance, the FIRST MESSAGE (and optionally the SECOND MESSAGE) is comprised in an Xn Setup procedure, while the THIRD, FOURTH and FIFTH MESSAGE are comprised in an AI/ML Information Reporting initialization XnAP procedure.
In another example of this embodiment, the FIRST MESSAGE and/or SECOND MESSAGE and any of the THIRD, FOURTH and FIFTH MESSAGE are comprised in different logical procedures for a signaling interface (e.g., the SECOND MESSAGE is comprised in an AI/ML Information Reporting Initiation XnAP procedure, and the FIRST MESSAGE is comprised in an AI/ML Information Reporting XnAP procedure.

A positive acknowledgment may be used to indicate that all the AI/ML assistance information requested by the second network node is available (full success) or that only part of the information is available (partial success).

### 2.1.3 Variant 1c

When the first network node transmits a partial positive acknowledgment or a negative acknowledgment of the information requested by the second network node, the FOURTH MESSAGE implicitly or explicitly indicates that the list of available AI/ML assistance information previously indicated by the first network node by means of a FIRST MESSAGE is outdated and/or no longer valid.

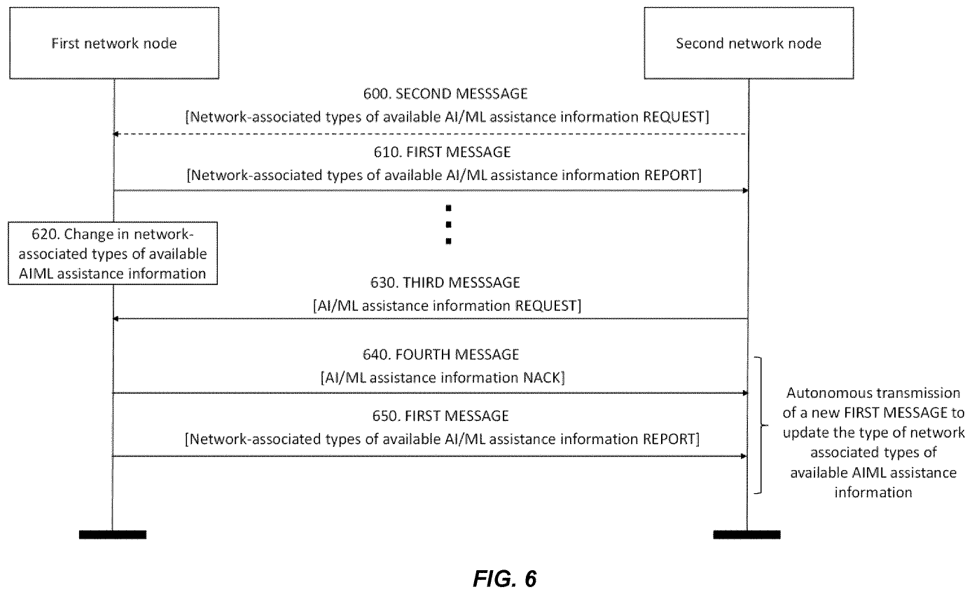

FIG. 6 illustrates one example embodiment of Variant 1c. Dashed lines indicate signals that are optionally transmitted in this example. Steps 600, 610, 630, and 640 are the same as or similar to steps 500, 510, 520, and 530, discussed above. In the example illustrated in FIG. 6, there is a change in the network-associated types of available AI/ML assistance information available at the first network node (step 620). The first network node may autonomously transmit a new FIRST MESSAGE to indicate an updated list of network-associated types of available AI/ML assistance information that the first network node may provide (step 650). The new FIRST MESSAGE could be transmitted to the second network node before or after or in alternative to transmitting the FOURTH MESSAGE in step 640 during a procedure related to AI/ML in RAN, such as an “AIML Assistance Information Reporting” XnAP procedure. In the example illustrated in FIG. 6, the new FIRST MESSAGE is transmitted by the first network node after the transmission of a FOURTH MESSAGE indicating, to the second network node, a negative or partial acknowledgement of the requested assistance information.

In another example (not illustrated by FIG. 6), the FIRST MESSAGE and the FOURTH MESSAGE can be the same kind of message (e.g., the transmission of the new FIRST MESSAGE may replace the transmission of the FOURTH MESSAGE). That is, by transmitting an updated set of types of network-associated types of available AI/ML assistance information to the second network node, the first network node may implicitly or explicitly provide a negative acknowledgement to a THIRD MESSAGE received from the second network node. In another example, the FOURTH MESSAGE may comprise a negative acknowledgment of the information requested by the THIRD MESSAGE and an updated list of network-associated types of available AI/ML assistance information of the first network node.

### 2.1.4 Variant 1d

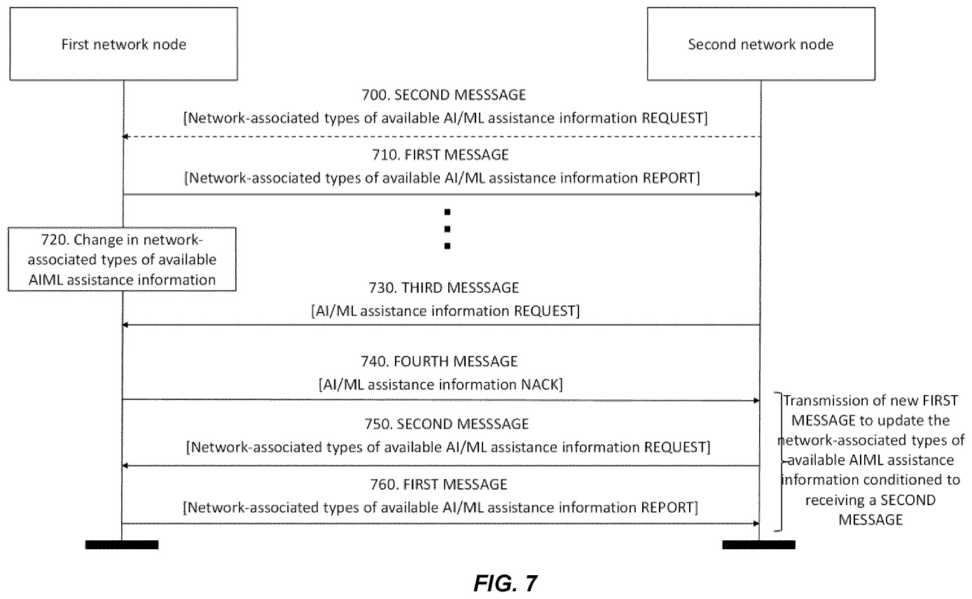

FIG. 7 shows an alternative example of how the first network node may indicate updated network-associated types of available AI/ML assistance information during a report procedure for AIML assistance information. Dashed lines indicate signals that are optionally transmitted in this example. Steps 700, 710, 720, 730, 740, and 760 are the same as steps 600, 610, 620, 630, 640, and 650 of FIG. 6. In this example, the first network, upon indicating with the FOURTH MESSAGE that one or more network-associated AI/ML assistance information requested by the second network node is no longer available (e.g., by means of a negative or partial acknowledgement of the requested assistance information), may transmit a new FIRST MESSAGE to the second network node with an updated list of network-associated types of available AI/ML assistance information conditioned to receiving from the second network node a new SECOND MESSAGE requesting to indicate such information (step 750).

### 2.2 First Message

The FIRST MESSAGE is sent from the first network node to the second network node and comprises one or more of:
An indication of the network-associated types of available AI/ML assistance information of the first network node. In one example, the network-associated types of available AI/ML assistance information that the first node may provide could be represented as a list of information (e.g., as enumerated types). In another example, the first network node may indicate the network-associated types of available AI/ML assistance information with a bitmap, with each bit in the bitmap being associated to at least a type of RAN-associated AI/ML assistance information, with the bit value being set to 1 (or zero) to indicate the availability of the information or to zero (or 1, respectively) otherwise
an indication that the network-associated types of available AI/ML assistance information of the first network node is unchanged (still valid) compared to network-associated types of available AI/ML assistance information of the first network node comprised in a previously sent FIRST MESSAGE. This element can be included in alternative to the network-associated types of available AI/ML assistance information of the first network node
an indication that the network-associated types of available AI/ML assistance information of the first network node provided in the FIRST MESSAGE modifies/overrides previously communicated network-associated types of available AI/ML assistance information of the first network node
an indication that all or at least part of the network-associated types of available AI/ML assistance information of the first network node provided in a preceding FIRST MESSAGE is no longer valid
an indication that the network-associated types of available AI/ML assistance information of the first network node provided in the FIRST MESSAGE is an addition to network-associated types of available AI/ML assistance information of the first network node provided in a preceding FIRST MESSAGE
one or more new and/or updated network-associated types of available AI/ML assistance information of the first network node
(optional) a request to obtain the complete set of network-associated types of available AI/ML assistance information of the second network node
(optional) a request to obtain only new and/or updated network-associated types of available AI/ML assistance information of the second network node

### Conditions to Trigger Transmission of FIRST MESSAGE

In one embodiment, the first network node determines to send the FIRST MESSAGE upon fulfillment of certain conditions, such as:
determining new/updated network-associated types of available AI/ML assistance information pertaining the first network node
determining that all or at least part of network-associated types of available AI/ML assistance information pertaining the first network node and sent to the second network node in a preceding FIRST MESSAGE is no longer valid
to confirm that network-associated types of available AI/ML assistance information pertaining the first network node and sent to the second network node in a preceding FIRST MESSAGE is unchanged (still valid)
determining to send (or after sending) to the second network node, a SIXTH MESSAGE comprising a request to obtain from the second network node a set of one or more predicted metric(s) (with/without specifying whether said metric(s) is (are) to be used for AI/ML assistance)
determining to send to the second network node, a SIXTH MESSAGE comprising an action, or a recommendation obtained by mean of an AI/ML inference function deployed at the first network node
sending to the second network node a SIXTH MESSAGE comprising an AI/ML model ID.
(implicit request from the second network node) receiving a SECOND MESSAGE from the second network node comprising network-associated available AI/ML assistance information pertaining the second network node.

In one option, the FIRST MESSAGE and the THIRD MESSAGE are the same.

### Examples of FIRST MESSAGE for Variant 1 (Further Elaborated in Section 4.1)

In non-limiting examples of implementation, the FIRST MESSAGE can be realized by extending an existing 3GPP message, such as:
(XnAP 3GPP interface):
   an XN SETUP REQUEST XnAP message, XN SETUP RESPONSE XnAP message, an XN REMOVAL REQUEST XnAP message, an NG-RAN NODE CONFIGURATION UPDATE XnAP message, an NG-RAN NODE CONFIGURATION UPDATE ACKNOWLEDGE XnAP message, a RESOURCE STATUS REQUEST XnAP message, a RESOURCE STATUS RESPONSE XnAP message, a HANDOVER REQUEST XnAP message, a HANDOVER REQUEST ACKNOWLEDGE XnAP message, a RESOURCE STATUS UPDATE XnAP message, a RETRIEVE UE CONTEXT REQUEST XnAP message, a RETRIEVE UE CONTEXT RESPONSE XnAP message.
(F1AP 3GPP interface):
   an F1 SETUP REQUEST F1AP message, an F1 SETUP RESPONSE F1AP message, an F1 REMOVAL REQUEST F1AP message, a GNB-DU CONFIGURATION UPDATE F1AP message, a GNB-DU CONFIGURATION UPDATE ACKNOWLEDGE F1AP message, a GNB-CU CONFIGURATION UPDATE F1AP message, a GNB-CU CONFIGURATION UPDATE ACKNOWLEDGE F1AP message, a RESOURCE STATUS REQUEST F1AP message, a RESOURCE STATUS RESPONSE F1AP message, a RESOURCE STATUS UPDATE F1AP message.
(E1AP 3GPP interface)
   a GNB-CU-UP E1 SETUP REQUEST E1AP message, a GNB-CU-UP SETUP RESPONSE E1AP message, an E1 RELEASE REQUEST E1AP message, a GNB-CU-CP E1 SETUP REQUEST E1AP message, a GNB-CU-CP E1 SETUP RESPONSE E1AP message, a GNB-CU-UP CONFIGURATION UPDATE E1AP message, a GNB-CU-UP CONFIGURATION UPDATE ACKNOWLEDGE E1AP message, a GNB-CU-CP CONFIGURATION UPDATE E1AP message, a GNB-CU-CP CONFIGURATION UPDATE ACKNOWLEDGE E1AP message, a RESOURCE STATUS REQUEST E1AP message, a RESOURCE STATUS RESPONSE E1AP message, a RESOURCE STATUS UPDATE E1AP message.

### 2.3 SECOND MESSAGE and THIRD MESSAGE

The SECOND MESSAGE is sent from the second network node to the first network node and comprises one or more of:
a request to obtain a set of network-associated types of available AI/ML assistance information of the first network node. The requested set could be the complete set of network-associated types of available AI/ML assistance information or a partial set.
a request to obtain only new and/or updated network-associated types of available AI/ML assistance information of the first network node
(optional) network-associated types of available AI/ML assistance information of the second network node
(optional) an indication that network-associated types of available AI/ML assistance information of the second network node is unchanged (still valid) compared to network-associated types of available AI/ML assistance information of the second network node comprised in a previously sent SECOND MESSAGE. This element can be included in alternative to the network-associated types of available AI/ML assistance information of the first network node
(optional) an indication that network-associated types of available AI/ML assistance information of the second network node provided in the SECOND MESSAGE modifies/overrides previously communicated network-associated types of available AI/ML assistance information of the second network node
(optional) an indication that all or at least part of network-associated types of available AI/ML assistance-information of the second network node provided in a preceding SECOND MESSAGE is no longer valid
(optional) an indication that network-associated types of available AI/ML assistance information of thesecond network node provided in the SECOND MESSAGE is an addition to network-associated types of available AI/ML assistance information of the second network node provided in a preceding SECOND MESSAGE
(optional) one or more new and/or updated network-associated types of available AI/ML assistance information of the second network node

In non-limiting examples of implementation, the SECOND MESSAGE can be realized by extending an existing 3GPP messages as indicated for the FIRST MESSAGE, e.g. extending an existing 3GPP message such as XnAP 3GPP interface, F1AP 3GPP interface, E1AP 3GPP interface etc.

### Conditions to Trigger Transmission of SECOND MESSAGE

In one embodiment, the second network node determines to send the SECOND MESSAGE upon fulfillment of certain conditions, such as:
receiving from the first network node, a SIXTH MESSAGE comprising a request to provide to the first network node a set of one or more predicted metric(s) (with/without specifying whether said metrics are to be used for AI/ML assistance)
receiving from the first network node, a SIXTH MESSAGE comprising an action, or a recommendation obtained by means of an AI/ML inference function deployed at the first network node
receiving from the first network node, a SIXTH MESSAGE comprising an AI/ML Model ID
(implicit request from the first network node) receiving a FIRST MESSAGE from the first network node comprising network-associated types of available AI/ML assistance information pertaining the first network node.

### 2.4 Sixth Message

The SIXTH MESSAGE is sent from the first network node to the second network node and comprises one or more of:
a request to obtain from the second network node a set of one or more predicted metric(s) (with/without specifying whether said metric(s) is (are) to be used for AI/ML assistance)
   in one example, the SIXTH MESSAGE can be a XnAP RESOURCE STATUS REQUEST message, or an XnAP AIML ASSISTANCE DATA REQUEST comprising a request for one or more of predicted load related metrics, such as: a predicted Composite Available Capacity, a predicted Energy Efficiency, a predicted PRB utilization in DL/UL (for GBR/non-GBR), a predicted capacity per network slice, a predicted UE performance (such as UL/DL throughput), a predicted
an action or a recommendation obtained by mean of an AI/ML inference function deployed at the first network node

In non-limiting examples of implementation, the SIXTH MESSAGE can be realized by extending an existing 3GPP messages as indicated for the FIRST MESSAGE.

### 2.5 Network-Associated Types of Available AI/ML Assistance Information

Network-associated types of available AI/ML assistance information of a network node comprises one or more of:
Identifier(s) of types of AI/ML model(s) (e.g., feed-forward neural networks, convolutional neural networks, recurrent neural networks, graph neural networks, attention models, autoencoders, etc.),
An identifier of AI/ML algorithms supported (e.g., supervised learning, unsupervised learning, reinforcement learning, federated learning, etc.),
An indication of a certain number (e.g., a maximum number) of hidden layers that can be supported for a certain type of AI/ML model,
An indication of the size (e.g., maximum size) of the AI/ML model that can be supported for one or more types of supported AI/ML models,
An indication of a certain number (e.g., a maximum number) of hidden units/nodes per hidden layer that can be supported for a certain type of AI/ML model,
Identifier of AI/ML supported use cases and/or AI/ML related operations/procedures/functionalities (such as load balancing, energy savings, mobility, link adaptation, power control, antenna tilt, etc.),
An indication of the hardware dedicated to AIML processes, such as chipset type and/or model, storage capabilities, computational capabilities, CPU, GPU, etc.,
Information related to AI/ML capabilities of the network node and/or associated identifier(s),
Information related to AI/ML model requirements of the network node and/or associated identifier(s),
Information related to AI/ML model life-cycle management of the network node and/or associated identifier(s), for example:
   An indication indicating support for testing Life Cycle Management (LCM),
   One or more indicators indicating support for LCM procedures such as: activation/deactivation of AI/ML model, switching between AI/ML models, fallback to one AI/ML model, registration of an AI/ML model, updates of an AI/ML model,
Information about measurement(s) determined or obtained by the network node and/or associated identifier(s),
Information about predictions determined or obtained by the network node and/or associated identifier(s), Support to provide certain predictions, which may include one or more of:
   type of information for which predictions are supported,
   reference prediction time for which predictions can be supported, wherein the reference prediction time indicates the time in the future for which prediction of certain information can be determined,
      according to one embodiment, for a given type of information, predictions may be supported based on one or more reference prediction time
      according to another embodiment, reference prediction time may be indicated as a time offset from the time when a prediction is determined,
   AI/ML model prediction quality or performance associated to different type of information for which predictions can be provided and/or different type of supported reference prediction time,
      according to one embodiment, AI/ML model prediction quality or performance may be expressed as AI/ML model prediction accuracy, or AI/ML model prediction error, such as a mean squared error,
         Thereby, predictions of different type of information and/or associated to different reference prediction time may be available or supported with different AI/ML model prediction quality.
   one or more type of supported events or conditions that can be configured to trigger predictions. In addition, specific supported configurations for triggering events or conditions may be indicated, such as threshold values associated to specific parameters or measurements,
   reliability conditions associated predictions, i.e., conditions on the basis of which the provided predictions for a reference prediction time are reliable (or trustworthy, i.e., can be used), or are not reliable,
      according to one embodiment, reliability conditions may be associated to one or more of:
         information type for which predictions are supported
         reference prediction time for which predictions are supported, or
         a combination thereof,
   in some non-limiting examples, reliability conditions can pertain to coverage related information (e.g., a coverage state, or a coverage index for at least one cell or one reference signal beam), to energy (or power) related information (e.g., an energy efficiency index, or an energy consumption index, an energy consumption state, a power state, or a power index), a DRX (Discontinuous Reception) or DTX (Discontinuous Transmission) configuration, the availability and/or use of certain carrier frequencies, to certain Radio Access Technologies, to the use of certain transmission points, to the delivery of certain type of traffic (e.g., bursty traffic, periodic traffic, delay critical traffic),
Inferred action(s) determined or obtained by the network node and/or associated identifier(s),
An indication indicating support to provide feedback for an action triggered/recommended by an AI/ML model,
An indication indicating support for certain training strategy(ies),
An indication indicating support for partial AI/ML model training at UE side/network side,
An indication indicating support to infer certain information,
An indication indicating support to use certain inferred information,
An indication indicating support for periodic/aperiodic feedback assistance information (e.g., for AI/ML model monitoring).

### 3 Embodiments for Variant 2 (First Network Node and User Device) Variant 2a 3.1

A first network node sends the FIRST MESSAGE a to a UE comprising network-associated types of available AI/ML assistance information that the first network node (or a third network node via the first network node) can offer to the UE to assist an AI/ML model.

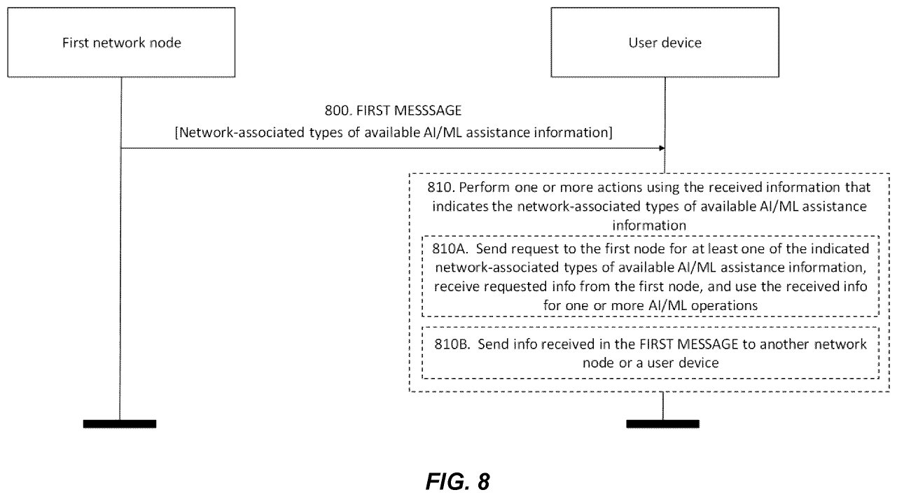

In this variant, illustrated in FIG. 8, the following steps are executed:
A first network node (or a third network node via a first network node) sends the FIRST MESSAGE to a UE comprising indication(s) of network-associated types of available AI/ML assistance information that the first network node (or the third network node via the first network node) can offer to the UE to assist an AI/ML model (step 800).

As also illustrated in FIG. 8, in one embodiment, the user device uses the received information that indicates the network-associated types of available AI/ML assistance information types pertaining the first network node that the first network node can provide to perform one or more actions. The one or more actions can be any desirable action(s) (step 810). For example, the user device may use this received information to request at least one of the network-associated types of available AI/ML assistance information from the first network node (step 810). The user device may then, for example, receive the at least one of the network-associated types of available AI/ML assistance information from the first network node and use this information for one or more AI/ML operations (e.g., train or update an AI or ML model, or any action that that can use the received information) (also see step 810A). As another example, the user device may send the information received in the FIRST MESSAGE to another network node or another user device (step 810B).

### Examples of FIRST MESSAGE for Variant 2 (Further Elaborated in Section 5)

In one example of any of variant 2, the FIRST MESSAGE is a signaling message not associated to a certain UE, in another variant, the FIRST MESSAGE is a signaling message associated to a certain UE.

In one example the FIRST MESSAGE, when transmitted by the first network node to a user device, may be realized and transmitted by means of a new RRC procedure/message, or reusing an existing procedure/message, such as an RRCReconfiguration message, an RRCSetup message, an RRCResume message.

### 3.2 Variant 2b (SEVENTH and EIGHTH MESSAGES)

The first network node sends the FIRST MESSAGE to a UE (or a group of UEs) comprising an indication indicating that the UE (or the group of UEs) can request to the network (on-demand) network-associated types of available AI/ML assistance information that the first network node (or a third network node via the first network node) can offer to the UE(s) to assist an AI/ML model.

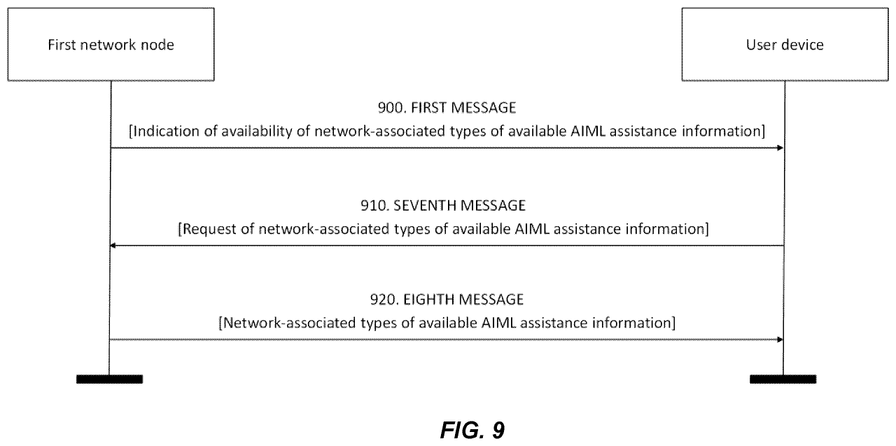

In this variant, illustrated in FIG. 9, the following steps are executed:
The first network node (or a third network node via a first network node) sends the FIRST MESSAGE to a UE (or a group of UEs) comprising indication(s) indicating that the UE (or the group of UEs) can request to the first network node (on-demand) network-associated types of available AI/ML assistance information that the first network node (or the third network node via the first network node) can offer to the UE to assist an AI/ML model (step 900).
   In one case, the first network node sends a broadcast message to a group of UE-for instance a system information message-containing at least one indication (e.g., a flag) indicating that the UE can request to the first network node certain network-associated types of available AI/ML assistance information. The first network node can also indicate a configuration (e.g., the configuration of Msg1 resources) that the UE needs to use for requesting System Information message(s) containing network-associated types of available AI/ML assistance information.
   In another case, the first network node sends a dedicated message to a specific UE indicating that the UE can request (on-demand) network-associated types of available AI/ML assistance information
The UE (or one of the UE in the group of UEs) transmits a SEVENTH MESSAGE to the first network node to request network-associated types of available AI/ML assistance information the first network node (or the third network node via the first network node) can provide to the UE for an AI/ML mode (step 910)I.
   In one example the SEVENTH MESSAGE transmitted by the UE to the first network node by means of a new RRC procedure/message, or reusing an existing procedure/message, such as an RRCSystem InfoRequest message (see, e.g., the example in Section 2.7.5)
The first network node sends an EIGHTH MESSAGE to the UE comprising the requested information (step 920). In one example, the EIGHT MESSAGE may be realized with an RRC signaling procedure similar to the FIRST MESSAGE described in variant 2a above.
   In one example the EIGHTH MESSAGE transmitted by the first network node to the UE by means of a new RRC procedure/message, or reusing an existing procedure/message, such as an RRCReconfiguration message, an RRCSetup message, an RRCResume message.

### 3.3 Variant 2c

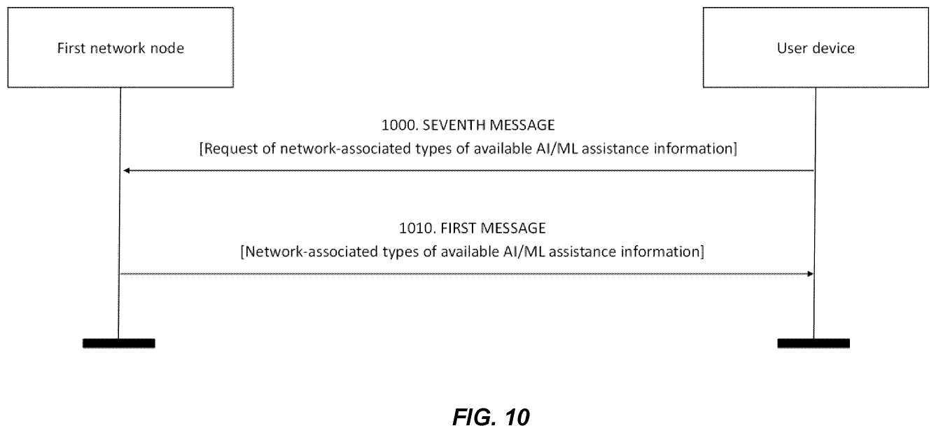

In one embodiment, illustrated in FIG. 10, the UE transmits a SEVENTH MESSAGE to the first network node to request network-associated types of available AI/ML assistance information that the first network node (or a third network node via the first network node) can offer to the UE(s) to assist an AI/ML model, without receiving any prior indication from the first network node of the availability of network-associated types of available AI/ML assistance information (step 1000). In this variant, the first network node may reply by transmitting to the user device a FIRST MESSAGE comprising network-associated types of available AI/ML assistance information that the first network node (or a third network node via the first network node) can offer to the UE(s) to assist an AI/ML operation at the user device (step 1010). Therefore, in this variant, the transmission of the FIRST MESSAGE from the first network node is conditions to prior receiving a SEVENTH MESSAGE from the user device.

### 4 Examples of Implementation for Variant 1

In this section some examples of implementations for variant 1 (first network node and second network node) are shown, where the parts marked in bold, italic and underlined pertains to additions of the present disclosure.

### 4.1 Examples for the FIRST MESSAGE

In one possible example of implementation, the FIRST MESSAGE is realized by a XN SETUP REQUEST XnAP message, extended to indicate RAN Associated Types Of Available AI/ML assistance information of the first network node (marked in bold, italic, underlined).

### 9.1.3.1 XN SETUP REQUEST

This message is sent by a NG-RAN node to a neighbouring NG-RAN node to transfer application data for an Xn-C interface instance.

Direction: NG-RAN node₁→NG-RAN node₂.

| | | | | | | |
|---|---|---|---|---|---|---|
| IE/Group | | | IE type | Semantics | | Assigned |
| Name | Presence | Range | and reference | description | Criticality | Criticality |

| | | | | | |
|---|---|---|---|---|---|
| Message | M | 9.2.3.1 | | YES | reject |
| Type | | | | | |
| Global | M | 9.2.2.3 | | YES | reject |
| NG-RAN Node ID | | | | | |
| TAI | M | 9.2.3.20 | List of | YES | reject |
| Support List | | | supported TAs | | |
| | | | and associated | | |
| | | | characteristics. | | |
| AMF | M | 9.2.3.83 | Contains a | YES | reject |
| Region Information | | | list of all | | |
| | | | the AMF | | |
| | | | Regions to | | |
| | | | which the NG- | | |
| | | | RAN node | | |
| | | | belongs. | | |

(skip unchanged)

| | | | | | |
|---|---|---|---|---|---|
| RAN | O | 9.2.3.xx | Contains a | YES | Ignore |
| Associated Types | | | list of RAN | | |
| Of Available AI/ML | | | Associated | | |
| Assistance | | | Types of | | |
| Information | | | Available | | |
| | | | AI/ML | | |
| | | | Assistance | | |
| | | | Information of | | |
| | | | NG-RAN node₁ | | |

In other possible example of implementation, the FIRST MESSAGE is realized by an AI/ML INFORMATION UPDATE XnAP (or alike), comprising an IE to signal RAN Associated Types Of Available AI/ML assistance information of the first network node (marked in bold, italic, underlined).

### 9.1.3.FF AI/ML Information Update

This message is sent by NG-RAN node₂ to NG-RAN node₁ to report the requested AI/ML related information.

Direction: NG-RAN node₂→NG-RAN node₁.

| | | | IE type | Semantics | | Assigned |
|---|---|---|---|---|---|---|
| IE/Group Name | Presence | Range | and reference | description | Criticality | Criticality |
| Message Type | M | | 9.2.3.1 | | YES | ignore |
| NG-RAN node1 | M | | INTEG ER | Allocated by | YES | reject |
| Measurement ID | | | (1 . . . 4095, . . .) | NG-RAN | | |
| | | | | node₁ | | |
| NG-RAN node2 | M | | INTEGER | Allocated by | YES | reject |
| Measurement ID | | | (1 . . . 4095, . . .) | NG-RAN | | |
| | | | | node₂ | | |
| Cell AI/ML Info | | 1 | | | YES | ignore |
| Result | | | | | | |
| >Cell AI/ML | | 1 . . . | | | | |
| Info Result Item | | <maxnoofCellsinNG- | | | | |
| | | RANnode> | | | | |
| >>Cell ID | M | | Global | | — | |
| | | | NG-RAN Cell | | | |
| | | | Identity | | | |
| | | | 9.2.2.27 | | | |
| >>Predicted | O | | 9.2.2.50 | | — | |
| Radio Resources Status | | | | | | |
| >>Predicted | O | | 9.2.2.62 | | — | |
| Number of Active UEs | | | | | — | |
| >>Predicted | O | | 9.2.2.56 | | — | |
| RRC Connections | | | | | | |
| RAN | O | | 9.2.3.xx | Contains | YES | Ignore |
| Associated Types Of | | | | a list | | |
| Available AI/ML | | | | of RAN- | | |
| Assistance Information | | | | associated | | |
| | | | | types of | | |
| | | | | available | | |
| | | | | AI/ML | | |
| | | | | Assistance | | |
| | | | | Information | | |
| | | | | of NG-RAN | | |
| | | | | node₂ | | |

A first example of RAN Associated Types Of Available AI/ML Assistance Information (9.2.3.xx) is provided below, where information is associated the sending network node.

### 9.2.3.xx RAN Associated Types Of Available AI/ML Assistance Information

This IF contains RAN-associated types of available AI/MI Assistance Information.

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| AI/ML Model | M | BIT | AI/ML | YES | reject |
| ID | | STRING | Model | | |
| | | (SIZE(64)) | Identifier | | |
| Available UE | M | | Indicates | YES | Ignore |
| Performance | | | the types | | |
| Predictions | | | of UE | | |
| | | | performance | | |
| | | | prediction | | |
| | | | available at | | |
| | | | the sender | | |
| | | | NG-RAN | | |
| | | | node | | |
| > DL | M | ENUMERATED | Indicates | | |
| Throughput | | (available, . . .) | that | | |
| | | | prediction | | |
| | | | of UE DL | | |
| | | | Throughput | | |
| | | | is available. | | |
| > UL | M | ENUMERATED | Indicates | | |
| Throughput | | (available, . . .) | that | | |
| | | | prediction | | |
| | | | of UE UL | | |
| | | | Throughput | | |
| | | | is available. | | |
| > Packet | O | ENUMERATED | Indicates | | |
| Loss | | (available, . . .) | that | | |
| | | | prediction | | |
| | | | of UE Packet | | |
| | | | loss is | | |
| | | | available. | | |
| Energy | M | ENUMERATED | Indicates | YES | Ignore |
| Efficiency | | (supported, . . .) | the | | |
| prediction | | | support for | | |
| | | | Energy | | |
| | | | Efficiency | | |
| | | | prediction | | |
| Number of | O | INTEGER | Indicates | YES | Ignore |
| hidden layers | | (32, . . .) | the | | |
| | | | maximum | | |
| | | | number of | | |
| | | | hidden layer | | |
| | | | supported | | |

A second example of RAN Associated Types Of Available AI/ML Assistance Information (9.2.3.xx) is provided below, where the Available AI/ML Assistance Information is provided per AI/ML Model.

### 9.2.3.xx RAN Associated Types Of Available AI/ML Assistance Information

This IE contains RAN Associated Types Of Available AI/ML Assistance Information.

| IE/Group | | | IE type and | Semantics | | Assigned |
|---|---|---|---|---|---|---|
| Name | Presence | Range | reference | description | Criticality | Criticality |
| AI/ML Model | M | 1 | | | YES | reject |
| Info List | | | | | | |
| > AI/ML | | 1 . . . | | Contains | | |
| Model Info Item | | <maxnoofAIMLModels> | | available | | |
| | | | | AI/ML | | |
| | | | | assistance | | |
| | | | | information | | |
| | | | | for one | | |
| | | | | AI/ML Model | | |
| >> AI/ML | M | | BIT | AI/ML Model | YES | reject |
| Model ID | | | STRING | Identifier | | |
| | | | (SIZE(64)) | | | |
| >> UE | M | | ENUMERATED | Indicates | YES | Ignore |
| Throughput | | | (supported, . . .) | the support | | |
| prediction | | | | for UE | | |
| | | | | throughput | | |
| | | | | prediction | | |
| >> Energy | M | | ENUMERATED | Indicates | YES | Ignore |
| Efficiency | | | (supported, . . .) | the support | | |
| prediction | | | | for Energy | | |
| | | | | Efficiency | | |
| | | | | prediction | | |

### 4.2 Examples for the SECOND MESSAGE

In one possible example of implementation, the SECOND MESSAGE is realized by an AI/ML INFORMATION REQUEST XnAP (or alike). One of IE in the message (e.g., the Report Characteristics IE) is extended to comprise a special bit, which, when set to 1, indicates a request for the RAN Associated Types Of Available AI/ML Assistance Information of the first network node (marked in bold, italic, underlined).

### 9.1.3.Ccaiml Information Request

This message is sent by NG-RAN node₁ to NG-RAN node₂ to initiate the requested AI/ML related information reporting according to the parameters given in the message.

Direction: NG-RAN node₁→NG-RAN node₂.

| IE/Group | | | IE type and | Semantics | | Assigned |
|---|---|---|---|---|---|---|
| Name | Presence | [symbol] ange | reference | description | Criticality | Criticality |
| Message | M | | 9.2.3.1 | | YES | reject |
| Type | | | | | | |
| NG-RAN | M | | INTEGER | Allocated | YES | reject |
| node1 Measurement | | | (1 . . . 4095, . . .) | by NG-RAN node₁ | | |
| ID | | | | | | |
| NG-RAN | C - | | INTEGER | Allocated | YES | ignore |
| node2 Measurement | ifRegistrationRequest | | (1 . . . 4095, . . .) | by NG-RAN node₂ | | |
| ID | Stop | | | | | |
| Registration | M | | ENUMERATED(start, | Types of | YES | reject |
| Request | | | stop, . . .) | RAN-associated | | |
| | | | | request for which | | |
| | | | | the AI/ML related | | |
| | | | | information is | | |
| | | | | required. | | |
| Report | C - | | BITSTRING | Each | YES | reject |
| Characteristics | ifRegistrationRequest | | (SIZE(32)) | position in the | | |
| | Start | | | bitmap indicates | | |
| | | | | the object the NG- | | |
| | | | | RAN node2 is | | |
| | | | | requested to | | |
| | | | | report. | | |
| | | | | First Bit = | | |
| | | | | Types of RAN | | |
| | | | | associated | | |
| | | | | Available AI/ML | | |
| | | | | Assistance | | |
| | | | | Information | | |
| | | | | Second Bit = | | |
| | | | | Predicted | | |
| | | | | Energy Efficiency | | |
| | | | | Third Bit = | | |
| | | | | Predicted | | |
| | | | | Composite | | |
| | | | | Available | | |
| | | | | Capacity, | | |
| | | | | Fourth Bit = | | |
| | | | | Predicted | | |
| | | | | Radio Resource | | |
| | | | | Status, . . . | | |
| Cell To | | [symbol] . . . 1 | | Cell ID | YES | ignore |
| Report List | | | | list to which the | | |
| | | | | request applies. | | |
| >Cell To | | [symbol] . . . | | | — | |
| Report Item | | <maxnoofCellsinNG- | | | | |
| | | RANnode> | | | | |
| >>Cell ID | M | | Global NG- | | — | |
| | | | RAN Cell | | | |
| | | | Identity | | | |
| | | | 9.2.2.27 | | | |
| Reporting | O | | ENUMERATED | Periodicity | YES | Ignore |
| Periodicity | | | (500 ms, 1000 ms, | that can be used | | |
| | | | 2000 ms, 5000 ms, | for reporting of | | |
| | | | 10000 ms, . . .) | requested objects. | | |
| | | | | Also used as the | | |
| | | | | averaging window | | |
| | | | | length for all | | |
| | | | | objects if | | |
| | | | | supported. | | |

[symbol]

indicates data missing or illegible when filed

According to one embodiment, if only the first bit (types of RAN associated available AI/ML assistance information) is set to 1, then it implies a request to receive assistance information for all available types of predictions and associated formats (e.g., the reference prediction time and/or reliability conditions).

According to another embodiment, if the first bit (types of RAN associated available AI/ML assistance information) is set to 1, and at least another bit associated to a specific prediction type is also set to 1 (e.g., the Second Bit associated to Predicted Energy Efficiency), then it implies a request to receive assistance information only for the indicated types of predictions.

### 4.3 Additional Examples for the FIRST MESSAGE and the SECOND MESSAGE

In a further example, related to XnAP interface and reported below (new elements marked in bold, italic and underlined), the first network node is a first NG-RAN node (NG-RAN node₁), the second network node is a second NG-RAN node (NG-RAN node₂), the FIRST MESSAGE and the SECOND MESSAGE are comprised in the same logical procedure for a signaling interface (e.g., the Xn Setup XnAP procedure). The SECOND MESSAGE is the initiating message of the procedure (e.g., the XN SETUP REQUEST XnAP message), and the FIRST MESSAGE is the response message of the same procedure (e.g., the XN SETUP RESPONSE XnAP message). In the specific example of implementation, the procedural text of the existing Xn Setup procedure is extended to include aspects concerning the Available AI/ML Assistance Information described in this disclosure:

If the RAN Associated Types Of Available AI/ML Assistance Information IE is included in the XN SETUP REQUEST message and if the NG-RAN node₂ is a gNB, the NG-RAN node₂ may include the Available AI/ML Assistance Information IE in the XN SETUP RESPONSE message.

In the same example, the XN SETUP REQUEST implementing the SECOND MESSAGE is extended as follows:

### 9.1.3.1 Xn Setup Request

This message is sent by a NG-RAN node to a neighbouring NG-RAN node to transfer application data for an Xn-C interface instance.

Direction: NG-RAN node₁→NG-RAN node₂.

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message | M | 9.2.3.1 | | YES | reject |
| Type | | | | | |
| Global | M | 9.2.2.3 | | YES | reject |
| NG-RAN Node ID | | | | | |
| TAI | M | 9.2.3.20 | List of | YES | reject |
| Support List | | | supported TAs | | |
| | | | and associated | | |
| | | | characteristics. | | |
| AMF | M | 9.2.3.83 | Contains a list | YEs | rejected |
| Region | | | of all the | | |
| Information | | | AMF Regions | | |
| | | | to which | | |
| | | | the NG-RAN | | |
| | | | node belongs. | | |

(skip unchanged)

| | | | | | |
|---|---|---|---|---|---|
| RAN | O | 9.2.3.xx | Contains a list | YES | Ignore |
| Associated Types | | | of available | | |
| Of Available | | | AI/ML | | |
| AI/ML | | | Assistance | | |
| Assistance | | | Information of | | |
| Information | | | NG-RAN node₁ | | |

In the same example, the XN SETUP RESPONSE implementing the FIRST MESSAGE is extended as follows:

### 9.1.3.2 Xn Setup Response

This message is sent by a NG-RAN node to a neighbouring NG-RAN node to transfer application data for an Xn-C interface instance.

Direction: NG-RAN node₂→NG-RAN node₁.

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| Global NG- | M | | 9.2.2.3 | | YES | reject |
| RAN Node ID | | | | | | |
| TAI Support | M | | 9.2.3.20 | List of | YES | reject |
| List | | | | supported | | |
| | | | | TAs and | | |
| | | | | associated | | |
| | | | | characteristics. | | |
| List of | | 0 . . . | | Contains a | YES | reject |
| Served Cells NR | | <maxnoofCellsinNG- | | list of cells | | |
| | | RAN node> | | served by | | |
| | | | | the gNB. If | | |
| | | | | a partial list | | |
| | | | | of cells is | | |
| | | | | signalled, it | | |
| | | | | contains at | | |
| | | | | least one cell | | |
| | | | | per carrier | | |
| | | | | configured | | |
| | | | | at the gNB | | |

(Skip unchanged)

| | | | | | |
|---|---|---|---|---|---|
| RAN | O | 9.2.3.xx | Contains a | YES | Ignore |
| Associated Types Of | | | list of | | |
| Available AI/ML | | | available | | |
| Assistance | | | AI/ML | | |
| Information | | | Assistance | | |
| | | | Information | | |
| | | | of NG-RAN | | |
| | | | node₁ | | |

In yet a further example, related to F1AP interface and reported below (marked in bold, italic and underlined), the first network node is a gNB-DU, the second network node is a gNB-CU, the FIRST MESSAGE is the F1 SETUP REQUEST F1AP message (from gNB-DU to gNB-CU) and the existing F1AP message is extended with a new Available AI/ML Assistance Information IE. The procedural text of the F1 Setup F1AP procedure is extended as indicated below: If the RAN Associated Types Of Available AI/ML Assistance Information IE is included in the Served Cell Information IE in the F1 SETUP REQUEST message, the gNB-CU shall, if supported, take it into account. Examples of Implementation for Variant 2 (First Network Node and User Device)

In this section some examples of implementations for variant 2 (first network node and user device) are shown, where the parts marked in bold, italic and underlined pertains to additions of the present disclosure.

### 5.1 Example of Implementation of FIRST MESSAGE

In another example of implementation, a gNB can send to a UE an RRC message (e.g., an RRCReconfiguration message) extended to indicate that the gNB can provide certain types of RAN-associated AI/ML assistance information.

```
alMLAvailableAssistanceInfoType-r19 SEQUENCE {
  cSIFeedbackEnhancement-r19 ENUMERATED { available }
OPTIONAL
  jointMLOperation-r19 ENUMERATED { available } OPTIONAL
}
```

| | |
|---|---|
| 5.2 | Example of Implementation of SEVENTH MESSAGE |

In an example of implementation, a UE request to a RAN node RAN-associated types of available AI/ML
assistance information by extending an RRCSystemInfoRequest RRC message.

| | |
|---|---|
| RRCSystemInfoRequest ::= | SEQUENCE { |

| | |
|---|---|
| criticalExtensions | CHOICE { |

| | |
|---|---|
| rrcSystemInfoRequest | RRCSystemInfoRequest-IEs, |
| criticalExtensionsFuture-r16 | CHOICE { |

| | |
|---|---|
| rrcPosSystemInfoRequest-r16 | RRC-PosSystemInfoRequest-r16-IEs, |

| | |
|---|---|
| criticalExtensionsFuture | SEQUENCE { } |

```
  }
  }
}
```

| | |
|---|---|
| RRCSystemInfoRequest-IEs ::= | SEQUENCE { |

| | |
|---|---|
| requested-SI-List | BIT STRING (SIZE (maxSI-Message), --32bits |
| spare | BIT STRING (SIZE (12)) |

}
RRC-PosSystemInfoRequest-r16-IEs ::= SEQUENCE {

| | |
|---|---|
| requestedPosSI-List | BIT STRING (SIZE (maxSI-Message)), --32bits |

| | |
|---|---|
| spare | BIT STRING (SIZE (11)) |

}
RRC-AIMLSystemInfoRequest-r19-IEs ::= SEQUENCE {
alMLAvailableAssistanceInfoTypeRequest-r19 BIT STRING (SIZE (maxSI-Message)), --32bits
}

### 6 Further Description

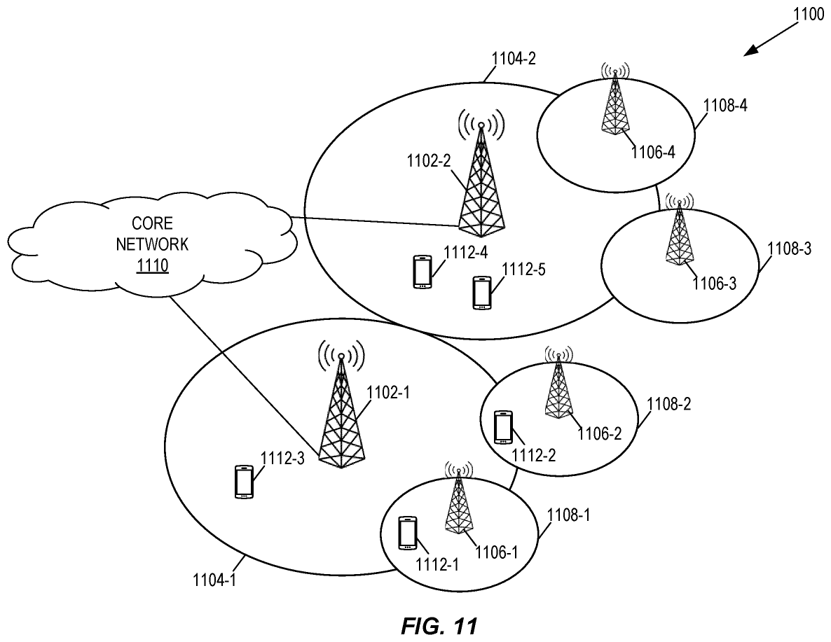

FIG. 11 illustrates one example of a cellular communications system 1100 in which embodiments of the present disclosure may be implemented. In the embodiments described herein, the cellular communications system 1100 is a 5G system (5GS) including a Next Generation RAN (NG-RAN) and a 5G Core (5GC); however, embodiments of the present disclosure may be implemented in other types of wireless communications systems such as, e.g., an EPS/LTE system, a 6th Generation (6G) system, or the like. In this example, the RAN includes base stations 1102-1 and 1102-2, which in the 5GS include NR base stations (gNBs) and optionally next generation eNBs (ng-eNBs) (e.g., LTE RAN nodes connected to the 5GC), controlling corresponding (macro) cells 1104-1 and 1104-2. The base stations 1102-1 and 1102-2 are generally referred to herein collectively as base stations 1102 and individually as base station 1102. Likewise, the (macro) cells 1104-1 and 1104-2 are generally referred to herein collectively as (macro) cells 1104 and individually as (macro) cell 1104. The RAN may also include a number of low power nodes 1106-1 through 1106-4 controlling corresponding small cells 1108-1 through 1108-4. The low power nodes 1106-1 through 1106-4 can be small base stations (such as pico or femto base stations) or RRHs, or the like. Notably, while not illustrated, one or more of the small cells 1108-1 through 1108-4 may alternatively be provided by the base stations 1102. The low power nodes 1106-1 through 1106-4 are generally referred to herein collectively as low power nodes 1106 and individually as low power node 1106. Likewise, the small cells 1108-1 through 1108-4 are generally referred to herein collectively as small cells 1108 and individually as small cell 1108. The cellular communications system 1100 also includes a core network 1110, which in the 5G System (5GS) is referred to as the 5GC. The base stations 1102 (and optionally the low power nodes 1106) are connected to the core network 1110.

The base stations 1102 and the low power nodes 1106 provide service to UEs 1112-1 through 1112-5 in the corresponding cells 1104 and 1108. The UEs 1112-1 through 1112-5 are generally referred to herein collectively as UEs 1112 and individually as UE 1112.

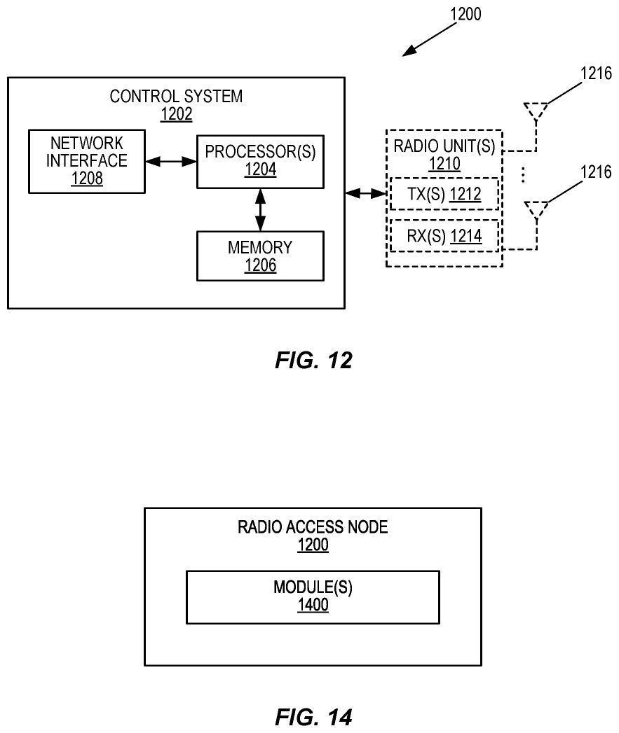

Note that the UEs 1112 may perform the functionality of the user device or UE described above, e.g., with respect to Variants 1-8. Further, in one embodiment, the base station 1102 is an example of the first network node described above, e.g., with respect to Variants 1-8. Still further, in one embodiment, the second network node described above, e.g., with respect to Variants 1-8, may be, e.g., another base station 1102 or a core network node. FIG. 12 is a schematic block diagram of a radio access node 1200 according to some embodiments of the present disclosure. Optional features are represented by dashed boxes. The radio access node 1200 may be, for example, a base station 1102 or 1106 or a network node that implements all or part of the functionality of the base station 1102 or gNB described herein. As illustrated, the radio access node 1200 includes a control system 1202 that includes one or more processors 1204 (e.g., Central Processing Units (CPUs), Application Specific Integrated Circuits (ASICs), Field Programmable Gate Arrays (FPGAs), and/or the like), memory 1206, and a network interface 1208. The one or more processors 1204 are also referred to herein as processing circuitry. In addition, the radio access node 1200 may include one or more radio units 1210 that each includes one or more transmitters 1212 and one or more receivers 1214 coupled to one or more antennas 1216. The radio units 1210 may be referred to or be part of radio interface circuitry. In some embodiments, the radio unit(s) 1210 is external to the control system 1202 and connected to the control system 1202 via, e.g., a wired connection (e.g., an optical cable). However, in some other embodiments, the radio unit(s) 1210 and potentially the antenna(s) 1216 are integrated together with the control system 1202. The one or more processors 1204 operate to provide one or more functions of a radio access node 1200 as described herein. In some embodiments, the function(s) are implemented in software that is stored, e.g., in the memory 1206 and executed by the one or more processors 1204.

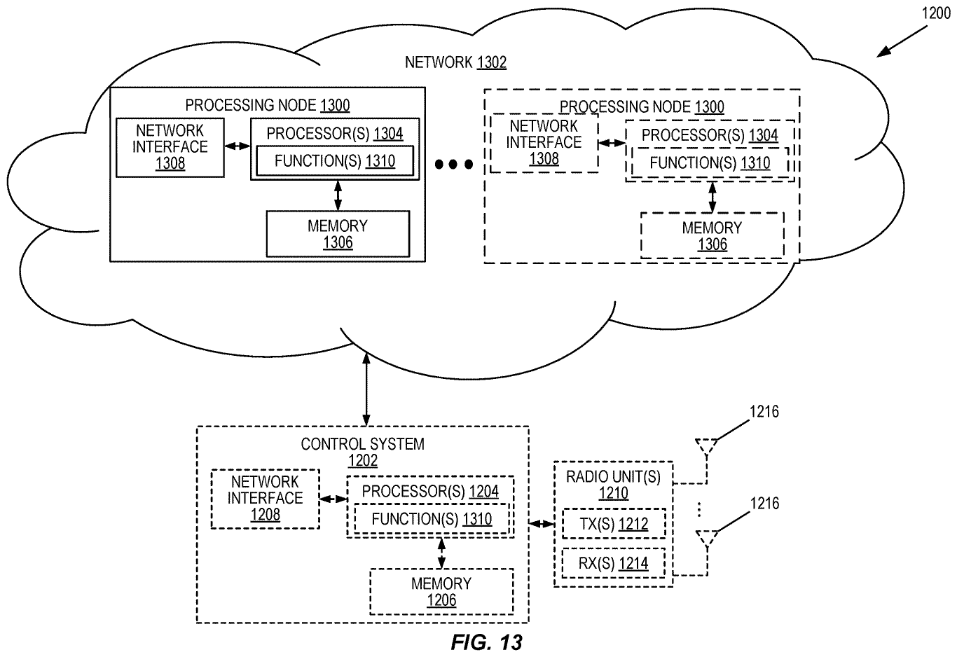

FIG. 13 is a schematic block diagram that illustrates a virtualized embodiment of the radio access node 1200 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1200 in which at least a portion of the functionality of the radio access node 1200 is implemented as a virtual component(s) (e.g., via a virtual machine(s) executing on a physical processing node(s) in a network(s)). As illustrated, in this example, the radio access node 1200 may include the control system 1202 and/or the one or more radio units 1210, as described above. The control system 1202 may be connected to the radio unit(s) 1210 via, for example, an optical cable or the like. The radio access node 1200 includes one or more processing nodes 1300 coupled to or included as part of a network(s) 1302. If present, the control system 1202 or the radio unit(s) are connected to the processing node(s) 1300 via the network 1302. Each processing node 1300 includes one or more processors 1304 (e.g., CPUs, ASICs, FPGAs, and/or the like), memory 1306, and a network interface 1308.

In this example, functions 1310 of the radio access node 1200 described herein are implemented at the one or more processing nodes 1300 or distributed across the one or more processing nodes 1300 and the control system 1202 and/or the radio unit(s) 1210 in any desired manner. In some particular embodiments, some or all of the functions 1310 of the radio access node 1200 described herein are implemented as virtual components executed by one or more virtual machines implemented in a virtual environment(s) hosted by the processing node(s) 1300. As will be appreciated by one of ordinary skill in the art, additional signaling or communication between the processing node(s) 1300 and the control system 1202 is used in order to carry out at least some of the desired functions 1310. Notably, in some embodiments, the control system 1202 may not be included, in which case the radio unit(s) 1210 communicate directly with the processing node(s) 1300 via an appropriate network interface(s).

In some embodiments, a computer program including instructions which, when executed by at least one processor, causes the at least one processor to carry out the functionality of radio access node 1200 or a node (e.g., a processing node 1300) implementing one or more of the functions 1310 of the radio access node 1200 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the radio access node 1200 according to some other embodiments of the present disclosure. The radio access node 1200 includes one or more modules 1400, each of which is implemented in software. The module(s) 1400 provide the functionality of the radio access node 1200 described herein. This discussion is equally applicable to the processing node 1300 of FIG. 13 where the modules 1400 may be implemented at one of the processing nodes 1300 or distributed across multiple processing nodes 1300 and/or distributed across the processing node(s) 1300 and the control system 1202.

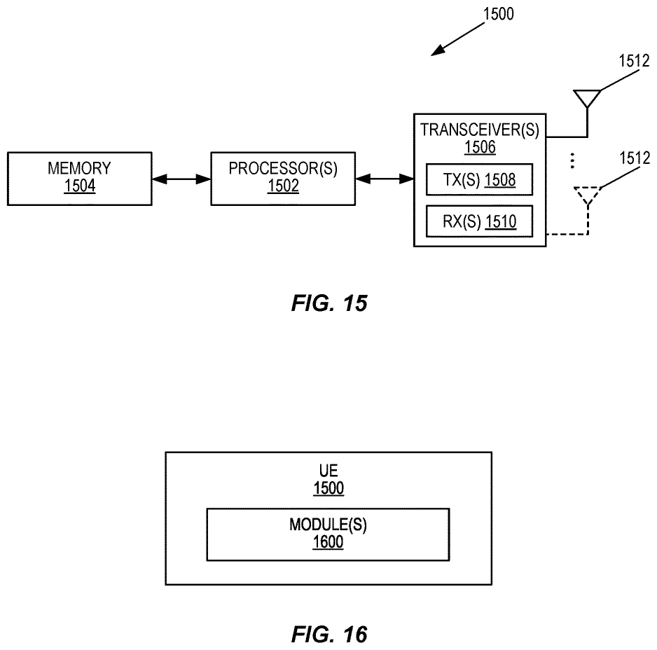

FIG. 15 is a schematic block diagram of a UE 1500 according to some embodiments of the present disclosure. As illustrated, the UE 1500 includes one or more processors 1502 (e.g., CPUs, ASICs, FPGAs, and/or the like), memory 1504, and one or more transceivers 1506 each including one or more transmitters 1508 and one or more receivers 1510 coupled to one or more antennas 1512. The transceiver(s) 1506 includes radio-front end circuitry connected to the antenna(s) 1512 that is configured to condition signals communicated between the antenna(s) 1512 and the processor(s) 1502, as will be appreciated by on of ordinary skill in the art. The processors 1502 are also referred to herein as processing circuitry. The transceivers 1506 are also referred to herein as radio circuitry. In some embodiments, the functionality of the UE 1500 described above may be fully or partially implemented in software that is, e.g., stored in the memory 1504 and executed by the processor(s) 1502. Note that the UE 1500 may include additional components not illustrated in FIG. 15 such as, e.g., one or more user interface components (e.g., an input/output interface including a display, buttons, a touch screen, a microphone, a speaker(s), and/or the like and/or any other components for allowing input of information into the UE 1500 and/or allowing output of information from the UE 1500), a power supply (e.g., a battery and associated power circuitry), etc.

In some embodiments, a computer program including instructions which, when executed by at least one processor, causes the at least one processor to carry out the functionality of the UE 1500 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the UE 1500 according to some other embodiments of the present disclosure. The UE 1500 includes one or more modules 1600, each of which is implemented in software. The module(s) 1600 provide the functionality of the UE 1500 described herein.

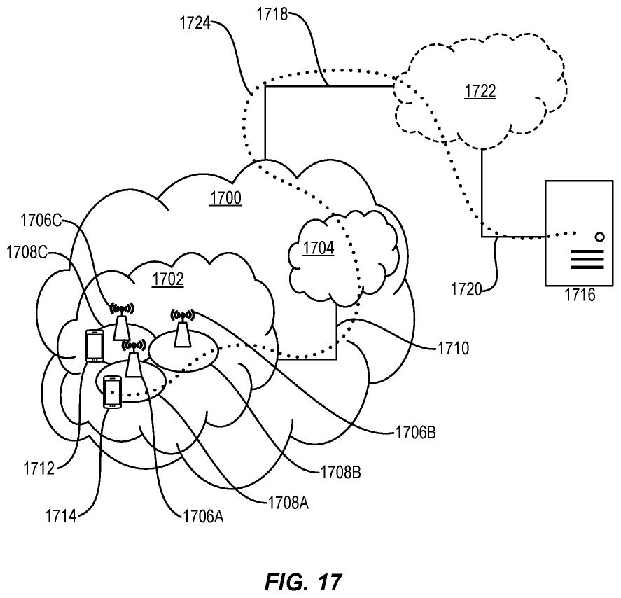

With reference to FIG. 17, in accordance with an embodiment, a communication system includes a telecommunication network 1700, such as a 3GPP-type cellular network, which comprises an access network 1702, such as a RAN, and a core network 1704. The access network 1702 comprises a plurality of base stations 1706A, 1706B, 1706C, such as Node Bs, eNBs, gNBs, or other types of wireless Access Points (APs), each defining a corresponding coverage area 1708A, 1708B, 1708C. Each base station 1706A, 1706B, 1706C is connectable to the core network 1704 over a wired or wireless connection 1710. A first UE 1712 located in coverage area 1708C is configured to wirelessly connect to, or be paged by, the corresponding base station 1706C. A second UE 1714 in coverage area 1708A is wirelessly connectable to the corresponding base station 1706A. While a plurality of UEs 1712, 1714 are illustrated in this example, the disclosed embodiments are equally applicable to a situation where a sole UE is in the coverage area or where a sole UE is connecting to the corresponding base station 1706.

The telecommunication network 1700 is itself connected to a host computer 1716, which may be embodied in the hardware and/or software of a standalone server, a cloud-implemented server, a distributed server, or as processing resources in a server farm. The host computer 1716 may be under the ownership or control of a service provider, or may be operated by the service provider or on behalf of the service provider. Connections 1718 and 1720 between the telecommunication network 1700 and the host computer 1716 may extend directly from the core network 1704 to the host computer 1716 or may go via an optional intermediate network 1722. The intermediate network 1722 may be one of, or a combination of more than one of, a public, private, or hosted network; the intermediate network 1722, if any, may be a backbone network or the Internet; in particular, the intermediate network 1722 may comprise two or more sub-networks (not shown).

The communication system of FIG. 17 as a whole enables connectivity between the connected UEs 1712, 1714 and the host computer 1716. The connectivity may be described as an Over-the-Top (OTT) connection 1724. The host computer 1716 and the connected UEs 1712, 1714 are configured to communicate data and/or signaling via the OTT connection 1724, using the access network 1702, the core network 1704, any intermediate network 1722, and possible further infrastructure (not shown) as intermediaries. The OTT connection 1724 may be transparent in the sense that the participating communication devices through which the OTT connection 1724 passes are unaware of routing of uplink and downlink communications. For example, the base station 1706 may not or need not be informed about the past routing of an incoming downlink communication with data originating from the host computer 1716 to be forwarded (e.g., handed over) to a connected UE 1712. Similarly, the base station 1706 need not be aware of the future routing of an outgoing uplink communication originating from the UE 1712 towards the host computer 1716.

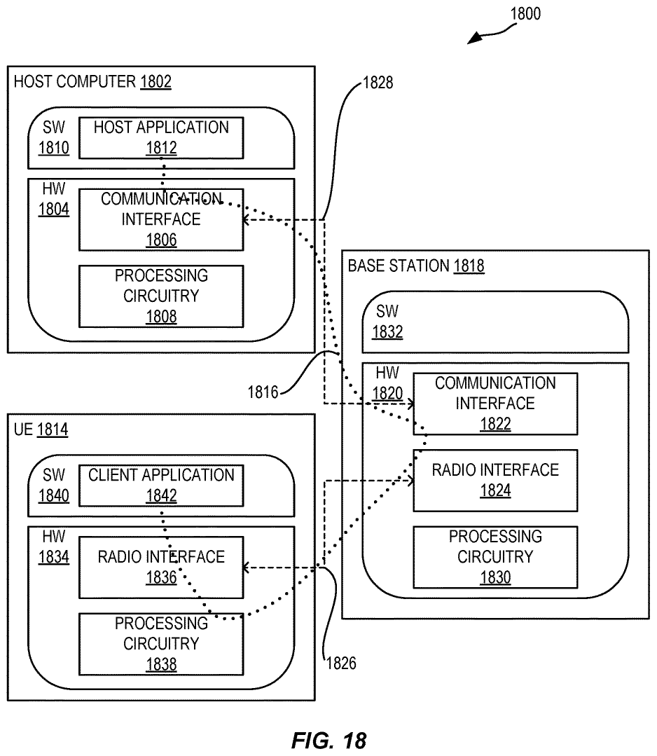

Example implementations, in accordance with an embodiment, of the UE, base station, and host computer discussed in the preceding paragraphs will now be described with reference to FIG. 18. In a communication system 1800, a host computer 1802 comprises hardware 1804 including a communication interface 1806 configured to set up and maintain a wired or wireless connection with an interface of a different communication device of the communication system 1800. The host computer 1802 further comprises processing circuitry 1808, which may have storage and/or processing capabilities. In particular, the processing circuitry 1808 may comprise one or more programmable processors, ASICs, FPGAs, or combinations of these (not shown) adapted to execute instructions. The host computer 1802 further comprises software 1810, which is stored in or accessible by the host computer 1802 and executable by the processing circuitry 1808. The software 1810 includes a host application 1812. The host application 1812 may be operable to provide a service to a remote user, such as a UE 1814 connecting via an OTT connection 1816 terminating at the UE 1814 and the host computer 1802. In providing the service to the remote user, the host application 1812 may provide user data which is transmitted using the OTT connection 1816.

The communication system 1800 further includes a base station 1818 provided in a telecommunication system and comprising hardware 1820 enabling it to communicate with the host computer 1802 and with the UE 1814. The hardware 1820 may include a communication interface 1822 for setting up and maintaining a wired or wireless connection with an interface of a different communication device of the communication system 1800, as well as a radio interface 1824 for setting up and maintaining at least a wireless connection 1826 with the UE 1814 located in a coverage area (not shown in FIG. 18) served by the base station 1818. The communication interface 1822 may be configured to facilitate a connection 1828 to the host computer 1802. The connection 1828 may be direct or it may pass through a core network (not shown in FIG. 18) of the telecommunication system and/or through one or more intermediate networks outside the telecommunication system. In the embodiment shown, the hardware 1820 of the base station 1818 further includes processing circuitry 1830, which may comprise one or more programmable processors, ASICs, FPGAs, or combinations of these (not shown) adapted to execute instructions. The base station 1818 further has software 1832 stored internally or accessible via an external connection.

The communication system 1800 further includes the UE 1814 already referred to. The UE's 1814 hardware 1834 may include a radio interface 1836 configured to set up and maintain a wireless connection 1826 with a base station serving a coverage area in which the UE 1814 is currently located. The hardware 1834 of the UE 1814 further includes processing circuitry 1838, which may comprise one or more programmable processors, ASICs, FPGAs, or combinations of these (not shown) adapted to execute instructions. The UE 1814 further comprises software 1840, which is stored in or accessible by the UE 1814 and executable by the processing circuitry 1838. The software 1840 includes a client application 1842. The client application 1842 may be operable to provide a service to a human or non-human user via the UE 1814, with the support of the host computer 1802. In the host computer 1802, the executing host application 1812 may communicate with the executing client application 1842 via the OTT connection 1816 terminating at the UE 1814 and the host computer 1802. In providing the service to the user, the client application 1842 may receive request data from the host application 1812 and provide user data in response to the request data. The OTT connection 1816 may transfer both the request data and the user data. The client application 1842 may interact with the user to generate the user data that it provides.

It is noted that the host computer 1802, the base station 1818, and the UE 1814 illustrated in FIG. 18 may be similar or identical to the host computer 1716, one of the base stations 1706A, 1706B, 1706C, and one of the UEs 1712, 1714 of FIG. 17, respectively. This is to say, the inner workings of these entities may be as shown in FIG. 18 and independently, the surrounding network topology may be that of FIG. 17.

In FIG. 18, the OTT connection 1816 has been drawn abstractly to illustrate the communication between the host computer 1802 and the UE 1814 via the base station 1818 without explicit reference to any intermediary devices and the precise routing of messages via these devices. The network infrastructure may determine the routing, which may be configured to hide from the UE 1814 or from the service provider operating the host computer 1802, or both. While the OTT connection 1816 is active, the network infrastructure may further take decisions by which it dynamically changes the routing (e.g., on the basis of load balancing consideration or reconfiguration of the network).

The wireless connection 1826 between the UE 1814 and the base station 1818 is in accordance with the teachings of the embodiments described throughout this disclosure. One or more of the various embodiments improve the performance of OTT services provided to the UE 1814 using the OTT connection 1816, in which the wireless connection 1826 forms the last segment.

A measurement procedure may be provided for the purpose of monitoring data rate, latency, and other factors on which the one or more embodiments improve. There may further be an optional network functionality for reconfiguring the OTT connection 1816 between the host computer 1802 and the UE 1814, in response to variations in the measurement results. The measurement procedure and/or the network functionality for reconfiguring the OTT connection 1816 may be implemented in the software 1810 and the hardware 1804 of the host computer 1802 or in the software 1840 and the hardware 1834 of the UE 1814, or both. In some embodiments, sensors (not shown) may be deployed in or in association with communication devices through which the OTT connection 1816 passes; the sensors may participate in the measurement procedure by supplying values of the monitored quantities exemplified above, or supplying values of other physical quantities from which the software 1810, 1840 may compute or estimate the monitored quantities. The reconfiguring of the OTT connection 1816 may include message format, retransmission settings, preferred routing, etc.; the reconfiguring need not affect the base station 1818, and it may be unknown or imperceptible to the base station 1818. Such procedures and functionalities may be known and practiced in the art. In certain embodiments, measurements may involve proprietary UE signaling facilitating the host computer's 1802 measurements of throughput, propagation times, latency, and the like. The measurements may be implemented in that the software 1810 and 1840 causes messages to be transmitted, in particular empty or ‘dummy’ messages, using the OTT connection 1816 while it monitors propagation times, errors, etc.

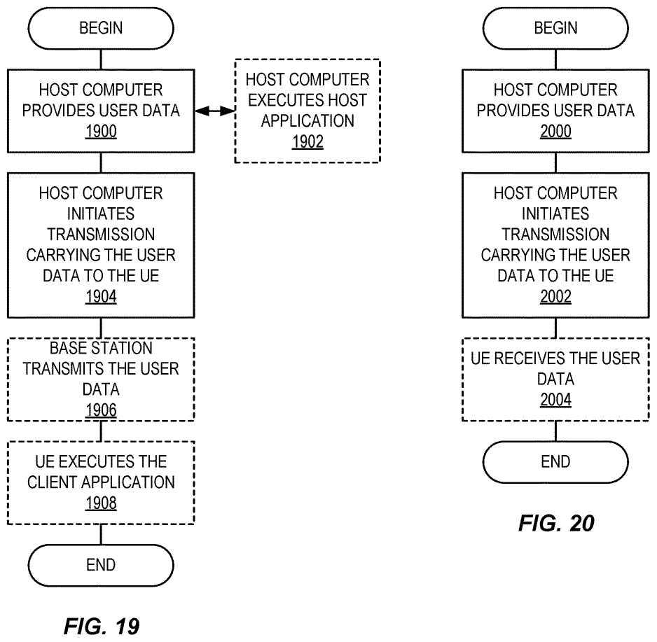

FIG. 19 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 19 will be included in this section. In step 1900, the host computer provides user data. In sub-step 1902 (which may be optional) of step 1900, the host computer provides the user data by executing a host application. In step 1904, the host computer initiates a transmission carrying the user data to the UE. In step 1906 (which may be optional), the base station transmits to the UE the user data which was carried in the transmission that the host computer initiated, in accordance with the teachings of the embodiments described throughout this disclosure. In step 1908 (which may also be optional), the UE executes a client application associated with the host application executed by the host computer.

FIG. 20 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 20 will be included in this section. In step 2000 of the method, the host computer provides user data. In an optional sub-step (not shown) the host computer provides the user data by executing a host application. In step 2002, the host computer initiates a transmission carrying the user data to the UE. The transmission may pass via the base station, in accordance with the teachings of the embodiments described throughout this disclosure. In step 2004 (which may be optional), the UE receives the user data carried in the transmission.

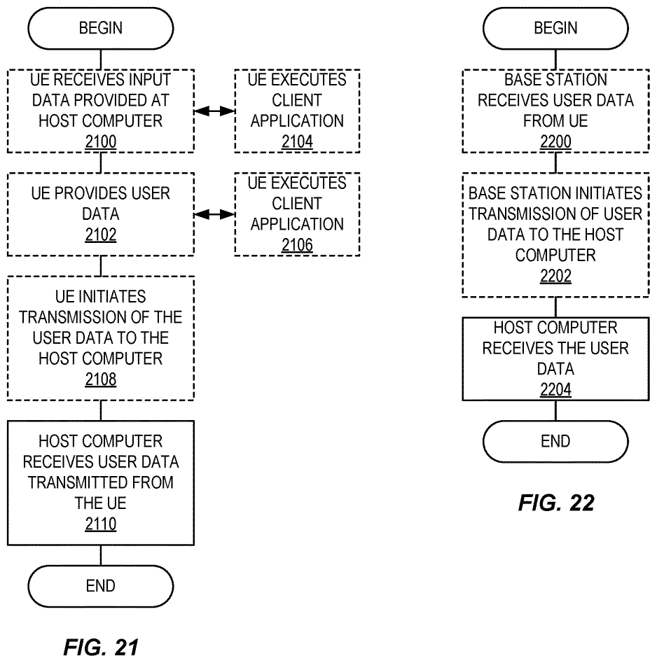

FIG. 21 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 21 will be included in this section. In step 2100 (which may be optional), the UE receives input data provided by the host computer. Additionally or alternatively, in step 2102, the UE provides user data. In sub-step 2104 (which may be optional) of step 2100, the UE provides the user data by executing a client application. In sub-step 2106 (which may be optional) of step 2102, the UE executes a client application which provides the user data in reaction to the received input data provided by the host computer. In providing the user data, the executed client application may further consider user input received from the user. Regardless of the specific manner in which the user data was provided, the UE initiates, in sub-step 2108 (which may be optional), transmission of the user data to the host computer. In step 2110 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 22 will be included in this section. In step 2200 (which may be optional), in accordance with the teachings of the embodiments described throughout this disclosure, the base station receives user data from the UE. In step 2202 (which may be optional), the base station initiates transmission of the received user data to the host computer. In step 2204 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed by a node (e.g., a second network node or a user device), comprising: receiving (210; 300; 410; 510; 610; 710; 800; 900; 1010), from a first network node, a first message comprising information that indicates network-associated types of available artificial intelligence, AI, or machine learning, ML, assistance information that the first network node can provide.

Embodiment 2: The method of embodiment 1 further comprising performing one or more actions using the received information.

Embodiment 3: The method of embodiment 2 wherein the one or more actions comprise sending a request to the first network node for at least one of the indicated network-associated types of available AI or ML assistance information.

Embodiment 4: The method of embodiment 2 wherein the one or more actions comprise: sending a request to the first network node for at least one of the indicated network-associated types of available AI or ML assistance information; receiving the at least one of the indicated network-associated types of available AI or ML assistance information from the first network node; and performing one or more AI or ML related operations (e.g., update or train an AI or ML model) based on the at least one of the indicated network-associated types of available AI or ML assistance information received from the first network node.

Embodiment 5: The method of embodiment 2 wherein the one or more actions comprise sending at least some of the received information to another node (e.g., to a network node or user device).

Embodiment 6: The method of any of embodiments 1 to 5 wherein the network-associated types of available AI or ML assistance information pertain to the first network node or a third network node.

Embodiment 7: The method of any of embodiments 1 to 6 wherein the node is a second network node. Embodiment 8: The method of embodiment 7 further comprising, prior to receiving the first message, sending (200; 400; 500), to the first network node, a request for the information that indicates network-associated types of available AI or ML assistance information pertaining to the first network node that the first network node can provide.

Embodiment 9: The method of embodiment 7 or 8 further comprising sending (420; 520; 630; 730), to the first network node, a request for at least one of the network-associated types of AI or ML assistance information pertaining to the first network node that the first network node can provide.

Embodiment 10: The method of embodiment 9 further comprising receiving (530), from the first network node, an ACK, partial ACK, or NACK in response to the request.

Embodiment 11: The method of embodiment 10 further comprising receiving (540), from the first network node, at least some of the requested at least one of the network-associated types of AI or ML assistance information pertaining to the first network node that the first network node can provide.

Embodiment 12: The method of embodiment 9 further comprising receiving (640; 740), from the first network node, a NACK or partial NACK in response to the request.

Embodiment 13: The method of embodiment 12 further comprising receiving (650; 760), from the first network node, updated information that indicates network-associated types of available AI or ML assistance information pertaining to the first network node that the first network node can provide.

Embodiment 14: The method of embodiment 13 further comprising, prior to receiving (760) the updated information from the first network node, sending (750), to the first network node, a request for (updated) information that indicates network-associated types of available AI or ML assistance information pertaining to the first network node that the first network node can provide.

Embodiment 15: The method of embodiment 7 further comprising sending (310) a second message to the first network node, the second message comprising information that indicates network-associated types of available AI or ML assistance information pertaining to the second network node that the second network node can provide.

Embodiment 16: the method of any of embodiments 1 to 5 wherein the node is a user device (e.g., a UE).

Embodiment 17: The method of embodiment 16 further comprising: sending (910), to the first network node, a request for at least one of the network-associated types of available AI or ML assistance information pertaining to the first network node that the first network node can provide; and receiving (920), from the first network node, the at least one of the network-associated types of available AI or ML assistance information pertaining to the first network node that the first network node can provide.

Embodiment 18: The method of embodiment 16 further comprising, prior to receiving the first message from the first network node, sending (1000), to the first network node, a request for the information that indicates network-associated types of available AI or ML assistance information pertaining to the first network node that the first network node can provide.

Embodiment 19: A node adapted to perform the method of any of embodiments 1 to 18.

Embodiment 20: A method performed by a first network node, comprising: sending (210; 300; 410; 510; 610; 710; 800; 900; 1010), to a node (e.g., a second network node or a user device), a first message comprising information that indicates network-associated types of available artificial intelligence, AI, or machine learning, ML, assistance information pertaining to the first network node that the first network node can provide.

Embodiment 21: the method of embodiment 20 wherein the node is a second network node.

Embodiment 22: The method of embodiment 21 further comprising, prior to sending the first message, receiving (200; 400; 500), from the second network node, a request for the information that indicates network-associated types of available AI or ML assistance information pertaining to the first network node that the first network node can provide.

Embodiment 23: The method of embodiment 21 or 22 further comprising receiving (420; 520; 630; 730), from the second network node, a request for at least one of the network-associated types of AI or ML assistance information pertaining to the first network node that the first network node can provide.

Embodiment 24: The method of embodiment 23 further comprising sending (530), to the second network node, an ACK, partial ACK, or NACK in response to the request.

Embodiment 25: The method of embodiment 24 further comprising sending (540), to the second network node, at least some of the requested at least one of the network-associated types of AI or ML assistance information pertaining to the first network node that the first network node can provide.

Embodiment 26: The method of embodiment 23 further comprising sending (640; 740), to the second network node, a NACK or partial NACK in response to the request.

Embodiment 27: The method of embodiment 26 further comprising sending (650; 760), to the second network node, updated information that indicates network-associated types of available AI or ML assistance information pertaining to the first network node that the first network node can provide.

Embodiment 28: The method of embodiment 27 further comprising, prior to sending (760) the updated information to the second network node, receiving (750), from the second network node, a request for (updated) information that indicates network-associated types of available AI or ML assistance information pertaining to the first network node that the first network node can provide.

Embodiment 29: The method of embodiment 21 further comprising receiving (310) a second message from the second network node, the second message comprising information that indicates network-associated types of available AI or ML assistance information pertaining to the second network node that the second network node can provide.

Embodiment 30: The method of embodiment 20 wherein the node is a user device (e.g., a UE).

Embodiment 31: The method of embodiment 30 further comprising: receiving (910), from the user device, a request for at least one of the network-associated types of available AI or ML assistance information pertaining to the first network node that the first network node can provide; and sending (920), to the user device, the at least one of the network-associated types of available AI or ML assistance information pertaining to the first network node that the first network node can provide.

Embodiment 32: The method of embodiment 30 further comprising, prior to sending the first message to the user device, receiving (1000), from the user device, a request for the information that indicates network-associated types of available AI or ML assistance information pertaining to the first network node that the first network node can provide.

Embodiment 33: A first network node adapted to perform the method of any of embodiments 20 to 32. Those skilled in the art will recognize improvements and modifications to the embodiments of the present disclosure. All such improvements and modifications are considered within the scope of the concepts disclosed herein.

1. A method performed by a node, comprising:
receiving, from a first network node, a first message comprising information that indicates network-associated types of available artificial intelligence (AI) or machine learning (ML) assistance information that the first network node can provide;
wherein the node is a second network node; and
wherein the information comprises any one or more of the following: information about measurement(s) determined or obtained by the network node and/or associated identifier(s), information about predictions determined or obtained by the first network node and/or associated identifier(s), information that indicates support to provide certain predictions.

2. The method of claim 1, further comprising performing (220-840) one or more actions using the received information.

3. The method of claim 2, wherein the one or more actions comprise sending a request to the first network node for at least one of the indicated network-associated types of available AI or ML assistance information.

4. The method of claim 2, wherein the one or more actions comprise:
sending a request to the first network node for at least one of the indicated network-associated types of available AI or ML assistance information;
receiving the at least one of the indicated network-associated types of available AI or ML assistance information from the first network node; and
performing one or more AI or ML related operations (e.g., update or train an AI or ML model) based on the at least one of the indicated network-associated types of available AI or ML assistance information received from the first network node.

5. (canceled)

6. The method of claim 1, wherein the network-associated types of available AI or ML assistance information pertain to the first network node or a third network node.

7. (canceled)

8. The method of claim 1, further comprising, prior to receiving the first message, sending, to the first network node, a request for the information that indicates network-associated types of available AI or ML assistance information pertaining to the first network node that the first network node can provide.

9. The method of claim 1, further comprising sending, to the first network node, a request for at least one of the network-associated types of AI or ML assistance information pertaining to the first network node that the first network node can provide.

10. The method of claim 4, further comprising receiving-(539), from the first network node, a success, a partial success, or a failure in response to the request.

11. The method of claim 6, further comprising receiving, from the first network node, at least some of the requested at least one of the network-associated types of AI or ML assistance information pertaining to the first network node that the first network node can provide.

12. The method of claim 4, further comprising receiving, from the first network node, a failure, or a partial failure in response to the request.

13. The method of claim 9, further comprising receiving, from the first network node, updated information that indicates network-associated types of available AI or ML assistance information pertaining to the first network node that the first network node can provide.

14. The method of claim 10, further comprising, prior to receiving the updated information from the first network node, sending, to the first network node, a request for (updated) information that indicates network-associated types of available AI or ML assistance information pertaining to the first network node that the first network node can provide.

15. The method of claim 4, further comprising sending a second message to the first network node, the second message comprising information that indicates network-associated types of available AI or ML assistance information pertaining to the second network node that the second network node can provide.

16.-18. (canceled)

19. The method of claim 1, wherein the information that indicates the network-associated types of available AI or ML assistance information that the first network node can provide comprises any one or more of the following:
one or more identifiers of one or more types of AI/ML models supported,
one or more identifiers of one or more AI/ML algorithms supported,
an indication of a certain number of hidden layers that can be supported for a certain type of AI/ML model,
an indication of a size of the AI/ML model that can be supported for one or more types of supported AI/ML models,
an indication of a certain number of hidden units or nodes per hidden layer that can be supported for a certain type of AI/ML model,
one or more identifiers of one or more AI/ML supported use cases and/or AI/ML related operations, procedures, or functionalities,
an indication of hardware dedicated to AI/ML processes,
information related to AI/ML capabilities of the first network node and/or associated identifier(s),
information related to AI/ML model requirements of the first network node and/or associated identifier(s),
information related to AI/ML model life-cycle management of the first network node and/or associated identifier(s),
information about inferred action(s) determined or obtained by the first network node and/or associated identifier(s),
an indication indicating support to provide feedback for an action triggered/recommended by an AI/ML model,
an indication indicating support for certain training strategy(ies),
an indication indicating support for partial AI/ML model training at user device side or network side,
an indication indicating support to infer certain information,
an indication indicating support to use certain inferred information,
an indication indicating support for periodic or aperiodic feedback assistance.

20. A node adapted to:
receive, from a first network node, a first message comprising information that indicates network-associated types of available artificial intelligence (AI) or machine learning (ML) assistance information that the first network node can provide;
wherein the node is a second network node; and
wherein the information comprises any one or more of the following: information about measurement(s) determined or obtained by the network node and/or associated identifier(s), information about predictions determined or obtained by the first network node and/or associated identifier(s), information that indicates support to provide certain predictions.

21.-23. (canceled)

24. A method performed by a first network node, comprising:
sending, to a second network node, a first message comprising information that indicates network-associated types of available artificial intelligence, AI, or machine learning, ML, assistance information pertaining to the first network node that the first network node can provide;
wherein the information comprises any one or more of the following: information about measurement(s) determined or obtained by the network node and/or associated identifier(s),information about predictions determined or obtained by the first network node and/or associated identifier(s), information that indicates support to provide certain predictions.

25. (canceled)

26. The method of claim 24, further comprising, prior to sending the first message, receiving, from the second network node, a request for the information that indicates network-associated types of available AI or ML assistance information pertaining to the first network node that the first network node can provide.

27. The method of claim 24, further comprising receiving, from the second network node, a request for at least one of the network-associated types of AI or ML assistance information pertaining to the first network node that the first network node can provide.

28. The method of claim 27, further comprising sending, to the second network node, a success, a partial success, or a failure in response to the request.

29.-36. (canceled)

37. A first network node adapted to:
send, to a second network node, a first message comprising information that indicates network-associated types of available artificial intelligence (AI) or machine learning (ML), assistance information pertaining to the first network node that the first network node can provide;
wherein the information comprises any one or more of the following; information about measurement(s) determined or obtained by the network node and/or associated identifier(s), information about predictions determined or obtained by the first network node and/or associated identifier(s), information that indicates support to provide certain predictions.

38.-40. (canceled)
